(19) United States
(12) Patent Application Publication
(10) Pub. No.: US 2012/0265590 A1
(43) Pub. Date: Oct. 18, 2012

(54) FLEXIBLE SHIP SCHEDULES AND DEMAND AGGREGATION

(76) Inventor: Gregory J. Mesaros, Tampa, FL (US)

(21) Appl. No.: 13/538,302

(22) Filed: Jun. 29, 2012

Related U.S. Application Data
(62) Division of application No. 11/152,462, filed on Jun. 14, 2005.
Application No. 11/152,462 is a continuation-in-part of application No. 10/370,237, filed on Feb. 20, 2003, now Pat. No. 7,124,099.
(60) Provisional application No. 60/579,812, filed on Jun. 15, 2004.

(51) Int. Cl. G06Q 30/02

(52) U.S. Cl. 705/14.13; 705/14.35

(57) ABSTRACT

Electronic buying and selling systems and methods are provided. In particular, relations among distinct price curves and buyers or potential buyers are disclosed. For instance, a price offered to a system user can vary based on total volume of all people aggregating in private environments, cumulative total order by user, ship date, optimal time, as well as terms and conditions associated with the offer (e.g., no cancellation of order, cancellation possible, payment method . . . ).

### CROSS-REFERENCE TO RELATED APPLICATIONS

The present patent application is a divisional and claims the priority benefit of U.S. patent application Ser. No. 11/152,462 filed Jun. 14, 2005, which claims the priority benefit of U.S. provisional application No. 60/579,812 filed Jun. 15, 2004. U.S. patent application Ser. No. 11/152,462 is also a continuation-in-part and claims the priority benefit of U.S. patent application Ser. No. 10/370,237 filed Feb. 20, 2003, now U.S. Pat. No. 7,124,099, the disclosures of which are incorporated herein by reference.

### TECHNICAL FIELD

The invention relates to an e-commerce and more particularly toward multiple criteria buying and selling systems and methodologies that facilitate conducting business electronically.

### BACKGROUND OF THE INVENTION

The buying and selling of products and services has resulted in a vast array of buying schemes which are used to vary the price at which such products are sold. One of the most common buying schemes which business encounter everyday is known as volume buying. According to this buying scheme, sellers set a fixed unit price for their products based on the volume of units that a buyer is willing to purchase. Buyers desiring to purchase products from the seller are each required to pay the same fixed price depending on the volume of units the buyer is purchasing. If a seller finds that the demand for a given product is greater or less than expected, the seller may later adjust the fixed price per unit of the product to account for such findings. Although the fixed price per unit system provides a simple way for a seller to conduct business with multiple buyers, one drawback of this buying scheme is that it fails to provide buyers with a choice between a variety of different buying criteria that may be just as important or even more important to the buyer than price.

For example, a buyer that is in need of goods, such as raw materials to make products for an expedited order may be willing to pay a higher price for a faster delivery time. Another buyer may be concerned with the quality of the goods they are purchasing, such that the buyer would pay a higher price for goods having a minimum number of defects. Yet another buyer may be concerned with the warranty time allotted for the goods they are purchasing, and may want the warranty of the goods that they are purchasing to match or exceed the warranty the buyers are offering their own customers.

Yet another buying scheme which has been advanced in recent years is buyer-driven bidding. According to this buying scheme, a single buyer desiring to obtain a product communicates a price at which the buyer is willing to purchase the product to multiple sellers. Each of the sellers is provided an opportunity to review the buyer's price. A sale is complete when one of the sellers agrees to sell the product to the buyer at the price suggested by the buyer. A buyer-driven bidding scheme is described in U.S. Pat. No. 5,794,207 assigned to Walker Asset Management Limited Partnership of Stamford, Conn. Another buyer-driven bidding scheme is described in U.S. Pat. No. 5,897,620 assigned to priceline.com, Inc. of Stamford, Conn. While the buyer-driven bidding scheme provides advantages for certain types of transactions when, for example, sellers may be willing to sell products at lower than normal prices, the uncertainties involved with whether a buyer's offer will be accepted is often problematic for high volume commercial transactions in which the reliability that a transaction will be complete is of paramount importance. Another problem with the present buying schemes is that the buyer's have no control in determining the criteria of the product or services that they may receive, while the seller has no control of the type of purchase that the buyer's request.

While the buying schemes described above have various advantages and disadvantages in different situations, a commonality among all of the buying schemes is that each buyer is not given the opportunity to choose amongst different buying criteria, which could be more important to the buyer than the price of the goods and/or services. Furthermore, each seller is not given a chance to offer their goods and/or services based on different selling criteria. In many instances sellers are not even aware of what buyer's consider important buying criteria. Additionally, sellers are sometimes not aware of what other selling criteria that other seller's might offer buyers.

Accordingly, there is a strong need in the art for a multiple criteria buying and selling scheme which provides both buyers and sellers more control in a commercial purchasing transaction, and overcomes the above mentioned drawbacks and others.

### SUMMARY OF THE CLAIMED INVENTION

The following presents a simplified summary in order to provide a basic understanding of some aspects of the claimed subject matter. This summary is not an extensive overview. It is not intended to identify key/critical elements or to delineate the scope of the subject invention. Its sole purpose is to present some concepts in a simplified form as a prelude to the more detailed description that is presented later.

Overall, the subject invention pertains to systems and methods directed toward e-commerce transactions and aggregation of demand. According to one aspect of the subject invention, a system that provides pricing information based in part on delivery date is provided. The system comprises a forecast component that acts to output a price estimate. The price estimate is based on an order related factor. After a price estimate has been generated, the estimate is passed to a price component. The price component generates and displays a price for the order that is based on the price estimate and the delivery date of the order.

In accordance with another aspect of the invention, an aggregation component can be included. The aggregation component contributes to the price estimate by selecting a price curve. A price curve is, among other things, a function of the price of a good based on the date that the good is desired by the buyer. Multiple price curves can exist for the same good. The aggregation component selects the price curve of the good based on a plurality of factors. For instance, if a buyer historically orders a large amount of good, and the buyer's current order is another large quantity, then the aggregation component can select a price curve having a more favorable price than one issued to a first time buyer that only wants a small quantity of good.

In accordance with yet another aspect of the invention, a buyer interface component can be included. The buyer interface component enables the buyer or potential buyer to enter the criteria for the sale of goods or services. This allows the buyer to communicate to a seller or group of sellers qualities of a transaction that are important to the buyer and to place limits on the transaction such as price, quantity, and terms. The buyer interface component can also be used to enter changes in conditions of an previous deal. In addition to allowing the buyer to enter deal criteria, the buyer interface component can also receive information. As such, the buyer interface component represents provides ease of exchange of information between a buyer or potential buyer and seller, sellers, or potential sellers.

The subject invention can also include a seller interface component. The seller interface component can allow the seller to interact with a buyer, buyers, or potential buyer or buyers. As such, the seller interface component allows the seller to enter information relating to features of the goods or services offered for sale or exchange. Additionally, the seller interface component further allows the seller to receive information about offers, deals, and commerce.

According to another aspect of the invention a notification component can be employed. The notification component can notify a buyer or seller of a deal, offer, invitation to deal, or some other aspect of commerce. The notification component can also notify the systems of the buyers, potential buyers, and sellers, to update the systems of the involved parties with the status of the related dealings.

In accordance with another aspect of the invention, a methodology is provided to obtain a price for a good. The method comprises determining the current and future need for the good, viewing the seller inventory, ordering goods for current and future delivery, and receiving the price for the good, based in part on the delivery date of an order.

In accordance with yet another aspect of the invention, a computer-implemented methodology is provided to output the price of a good. The method consists of receiving a purchase schedule comprising at least one of amount of a desired good, specified dates for purchase, and desired delivery dates, determining the price of the desired good based in part on an order related factor, evaluating a production schedule based on the quantity of the desired good in the purchase schedule, and generating a price estimate.

To the accomplishment of the foregoing and related ends, the invention then, comprises the features hereinafter fully described and particularly pointed out in the claims. The following description and the annexed drawings set forth in detail certain illustrative aspects of the invention. These aspects are indicative, however, of but a few of the various ways in which the principles of the invention may be employed and the subject invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

FIG. 1 illustrates a diagrammatic view of a system that provides pricing for an order of a quantity of goods.

FIG. 2a illustrates a diagrammatic view of an aggregation component contributing to price estimate.

FIG. 2b is a graph that illustrates changes in price curves for a specified product, in accordance with an aspect of the current invention.

FIG. 3 illustrates a diagrammatic view of a buyer interface component that factors into a price calculation.

FIG. 4 illustrates a seller interface component providing information into a forecasting component.

FIG. 5 illustrates a notification component that outputs transaction information.

FIG. 6 is a flow chart diagram of a methodology to obtain a price for a good, in accordance with an aspect of the subject invention.

FIG. 7a is a flow chart diagram of a methodology for generation of a price estimate.

FIG. 7b is a method of setting a buyer curve in accordance with an aspect of the subject invention.

FIG. 8 illustrates a diagrammatic view of a system for electronically conducting business in accordance with one aspect of the invention.

FIG. 9 illustrates a block diagram of a central server in accordance with one aspect of the subject invention.

FIG. 10 illustrates a web page providing options to buyers and sellers desiring to conduct business electronically in accordance with one aspect of the subject invention.

FIG. 11a illustrates a buyer's buying criteria input screen in accordance with one aspect of the subject invention.

FIG. 11b illustrates a buyer's product ordering criteria input screen in accordance with one aspect of the subject invention.

FIG. 11c illustrates a list of seller's deals matching the buyer's product ordering criteria in accordance with one aspect of the subject invention.

FIG. 12 illustrates a flow chart for a buyer desiring to conduct business electronically in accordance with one aspect of the subject invention.

FIG. 13 illustrates an on-line registration form for a buyer in accordance with one aspect of the subject invention.

FIG. 14 illustrates a buyer database stored in a central server in accordance with one aspect of the subject invention.

FIG. 15a illustrates a web page for a buyer to create or modify a deal in accordance with one aspect of the subject invention.

FIG. 15b illustrates a seller's buying and selling criteria input screen in accordance with one aspect of the subject invention.

FIG. 15c illustrates a seller's product ordering criteria input screen in accordance with one aspect of the subject invention.

FIG. 15d illustrates an input screen for adding buying and selling criteria to the deal in accordance with one aspect of the subject invention.

FIG. 16 illustrates a flow chart for a seller desiring to conduct business electronically in accordance with one aspect of the subject invention.

FIG. 17 illustrates an on-line registration form for a seller in accordance with one aspect of the subject invention.

FIG. 18 illustrates a seller database stored in the central server in accordance with one aspect of the subject invention.

FIG. 19 is a schematic illustration of an electronic forum for conducting a seller sponsored business transaction.

FIG. 20 is a schematic illustration of an electronic forum for conducting a buyer sponsored business transaction.

FIG. 21 is a schematic illustration of an electronic forum for conducting a buyer and seller co-sponsored business transaction.

FIG. 22 is an example of a price curve in accordance with one aspect of the subject invention.

FIG. 23 is an example of another price curve in accordance with one aspect of the invention.

FIG. 24 is an example of a spot curve in accordance with one aspect of the subject invention.

FIG. 25 is an example of a multidimensional price curve in accordance with one aspect of the subject invention.

FIG. 26 is an example of a seasonal price curve in accordance with one aspect of the subject invention.

FIG. 27 is an example of another price curve in accordance with one aspect of the subject invention.

FIG. 28 is a feedback control system which employs an aggregation component in accordance with an aspect of the subject invention.

FIG. 29 illustrates a method of aggregating demand across deal rooms in accordance with an aspect of the subject invention.

### DETAILED DESCRIPTION

The subject invention is now described with reference to the annexed drawings, wherein like numerals refer to like elements throughout. It should be understood, however, that the drawings and detailed description thereto are not intended to limit the invention to the particular form disclosed. Rather, the intention is to cover all modifications, equivalents, and alternatives falling within the spirit and scope of the subject invention.

As used in this application, the terms “component,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

It should be appreciated that the invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Of course, those skilled in the art will recognize many modifications may be made to this configuration without departing from the scope or spirit of the subject invention.

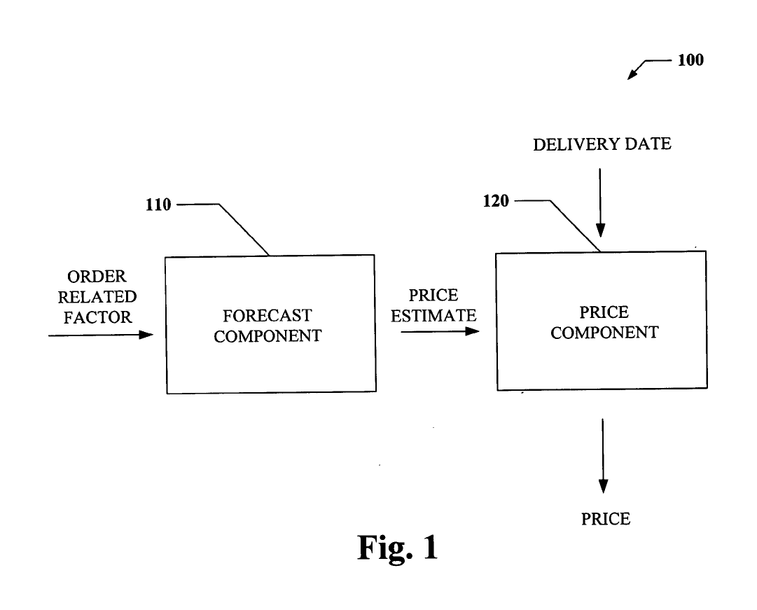

Referring initially to FIG. 1, a price system 100 is depicted in accordance with an aspect of the invention. System 100 includes a forecast component 110 and a price component 120. Forecast component 110 receives one or more order related factors and provides a price estimate for an order of goods/services based at least upon one received factor. Forecast component 110 can also display an estimation of the price of a good and/or service to the buyer based at least in part upon an order related factor.

Order related factors pertain to characteristics of an order. Such order related factors can include but are not limited to current supplier production, supplier inventory, time, customer (e.g., buyer) size, past order history of customer, current price, volume ordered to date, historical quantity ordered, and conditional offers from a supplier.

The price estimate produced by the price component 110 is provided to and received by price component 120. The price component 120 generates and displays the price based at least in part on the price estimate and the delivery date of the desired good/service. For instance, if a buyer orders a quantity of good, and indicates that the delivery date shall be as soon as possible. Such an indication would affect the price of a good since the rapid delivery does not allow the seller to plan for availability of the good in response to other orders and the current order. For example, a production run could not be scheduled to produce goods for everyone. Thus, the price component 120 can modify the price or a price schedule in accordance with delivery information and display an altered price or price schedule.

The choice to purchase the goods at a certain time can be dependent upon the buyer's request. Accordingly, a list of shipping options can be presented to the buyer and his/her decision can be made based on the options and corresponding prices. By way of example and not limitation consider the following table of shipping options and associated pricing:

TABLE A

| Shipping Options | Pricing |
|---|---|
| Ship immediately | Price is now held at what is currently shown |
| Ship within 48 hours | Final price will be what is the price shown |
| | in 48 hours Final |
| Ship within 5 days | Posted ship price is what is shown on day 4 |

In this manner, a buyer can review and select to have the product shipped immediately or at some other time. The system can record the price at the time of order and ship schedule selected. The customer invoice would reflect this amount and the order would be processed into the supplier's and buyer's respective ordering systems automatically.

In another example, a buyer may request to purchase a good, but require that the good be held by the seller for one month. Additionally, there may be a conditional offer from the seller that discounts the price of a good by a certain percentage. In analyzing both order related factors from the buyer, the forecast component 110 will provide a price estimate reflecting the effect of these two factors in the subject example. The specification of a hold time serves to increase the price of the good/service, since the seller must now retain the good in inventory. Additionally, the conditional offer serves to decrease the price of the good by the amount specified. Accordingly, the price estimate is adjusted accordingly in response to the order related factors.

It is to be appreciated that aspects of the subject invention have wide applicability to the purchasing and/or selling of a variety of different products and/or services. For example, the subject invention may be applied within the context of purchasing and/or selling airline tickets wherein order related factors may include, for example: (1) reputation of airline; (2) reliability; (3) timeliness; (4) price; (5) number of alternative flights; (6) comfort; (7) quality of service; and (8) quality of foods. Additional order related factors may include for example: (1) volume of tickets; (2) buyer's versatility in time schedule; (3) buyer's method of payment, etc.

Aspects of the invention may also be applied in the context of purchasing and/or selling an automobile wherein order related factors may include, for example: (1) reputation of automobile manufacturer; (2) reputation of dealer; (3) price of automobile; (4) delivery options; (5) automobile availability; (6) safety; and (7) financing terms; etc. Further order related factors may include, for example: (1) buyer's creditworthiness; (2) desired finance terms; (3) delivery requests of buyer; and (4) delivery dates.

The subject invention allows buyers and/or sellers of products and/or services to pre-select a plurality of criteria prior to negotiating a deal for the product and/or service. Of course the pre-selected criteria will vary depending on the particular product and/or service. The scope of the invention as defined in the hereto appended claims intends to include any product and/or service (and plurality of pre-selected criteria associated therewith) suitable for deal-making in accordance with the subject invention.

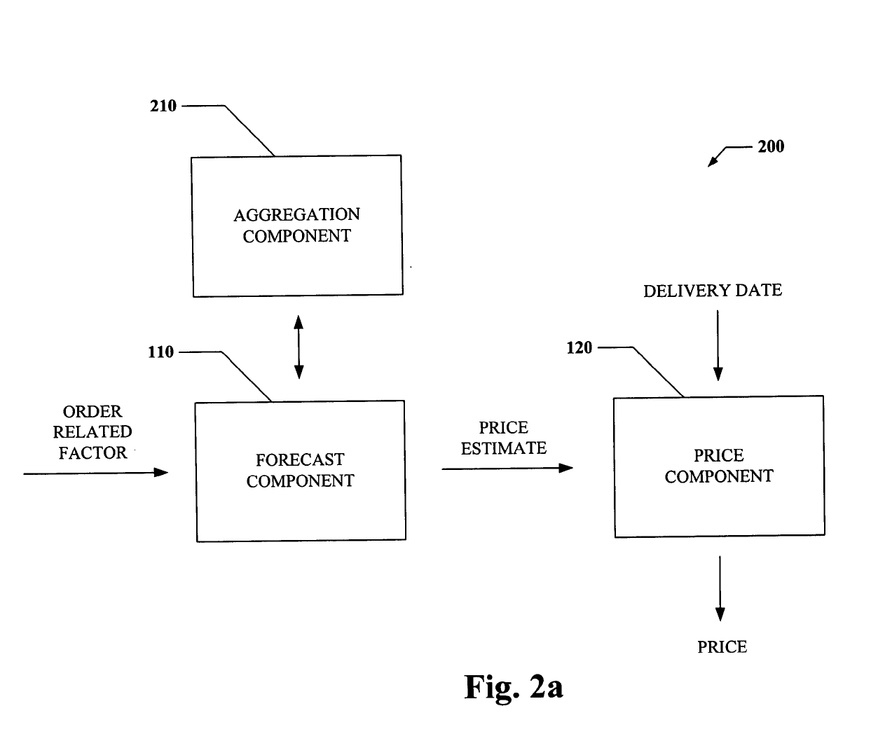

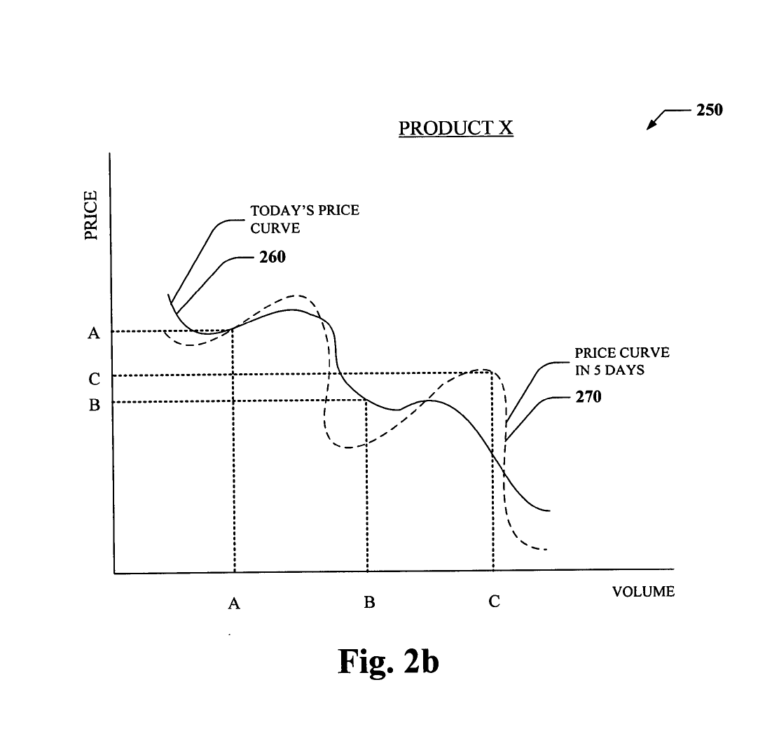

FIG. 2a provides a price system 200 in accordance with an aspect of the subject invention. In addition to the forecast component 110 and the price component 120 as described with respect to system 100 of FIG. 1, system 200 includes an aggregation component 210. Aggregation component 210 can be communicatively coupled to the forecast component 110 and contribute to the price estimate generated thereby via selection of a price curve. A price curve is a function that provides a price for a good and/or service based on volume ordered, amongst other things. Multiple price curves can exist for the same good and can also be provided to different buyers or groups of buyers. The aggregation component 210 selects the price curve of a good based on a plurality of factors, including but not limited to order history of the buyer, volume of the good ordered to date, historical quantity ordered by the buyer, and orders for the same good from other buyers.

As an example, if a buyer historically orders a large amount of good, and the buyer's current order is a large quantity, then the aggregation component 210 can select a price curve having a more favorable price than one issued to a first time buyer that only orders a small quantity. Additionally, the aggregation component 210 can be used to vary the price of a good depending on demand of the good from a plurality of orders, for instance in or amongst a deal room as described in further detail infra. As such, the aggregation component 210 allows the seller to set the price of a good in response to customer specific stimuli and in response to factors relating to the good from orders of other customers. For instance, if the quantity of orders and/or amount of good per order for a good increase, the aggregation component 210 can increase the price per good accordingly until a certain sales volume or profit margin is attained. The aggregation component 210 can also assign different price curves to different buyers depending on buyer specific factors. As such, the aggregation component 210 affords the seller much control in the sale of goods.

Upon selection of a price curve, the price estimate can be provided to the price component 120, which may alter the price curve or estimate base on delivery date or other delivery information. As an alternative, it should be appreciated that delivery information such as date could be included as an order related factor and forecast component 110 and aggregation component 210 could interact to facilitate selection of a price estimate, price curve, or schedule that takes such information into account.

FIG. 2b illustrates an exemplary graph 250 for a product X that represents price curves 260 and 270. Price curve 260 represents the cost of a good versus volume if the good were purchased and/or delivered today. Price curve 260 varies from price curve 270, which illustrates the price versus volume for a purchase and/or delivery at a time five days from now. Although price curves 260 and 270 differ due to different delivery times, it is to be understood that two price curves containing identical date criteria can differ due to other related factors. As such, an aggregation component or system can interpolate information of a plurality of offers and/or deal related information and assign a specific price curve to a buyer or potential buyer. Alternatively, a particular price curve can be modified based on delivery time.

Three points are delineated on the graph 250 to represent three different volumes which correlate to three disparate prices per unit for the buyer. It is to be appreciated that the volume and corresponding price for product X can vary for disparate price curves. Further, it is to be appreciated that the price curves can be representative of various other factors beyond the price and volume shown in this particular approach. For instance, the price curve can be related to current supplier production, purchasing history of the buyer, etc. Point A represents a price and corresponding volume of product X wherein today's price versus volume at A is the same as the price curve for the same price and volume in two weeks. In contrast, the volume at point B illustrates a decrease in the price of product X if the good is purchased and/or delivered in two weeks. Alternatively, point C shows an increase in price per unit relative to volume if the buyer waits two weeks to place an order instead of placing such an order on the current day or opts for delivery in two weeks rather than some other date.

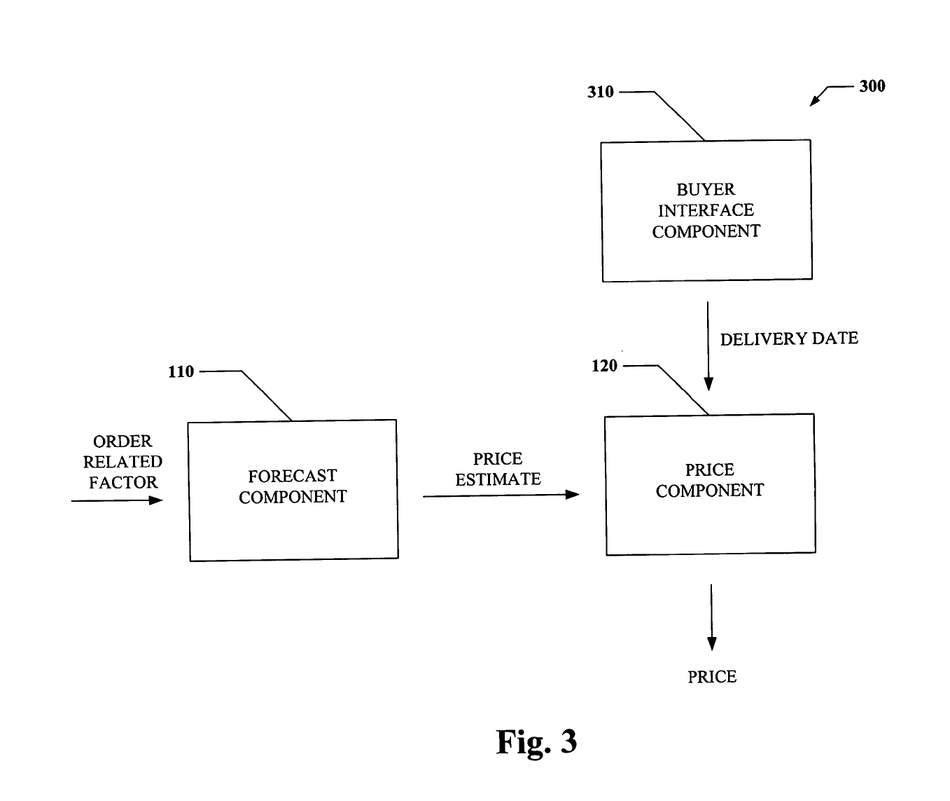

Referring now to FIG. 3, a system 300 is provided that includes a forecast component 110 and a price component 120 as previously described. Furthermore, system 300 includes a buyer interface component 310 that, inter alia, provides a mechanism to enable a buyer or potential buyer to input criteria into and otherwise interact with the price component 120. Such information can include delivery dates for an order of a quantity of goods. Thus, the buyer can order a specific quantity of goods, and indicate disparate ship dates for an order of a certain good. For example, a buyer may order a quantity of ten units, but only needs two units shipped now, two units shipped in five days, and the remainder on a later posted ship date. The buyer interface component 310 allows the buyer to order all goods with different ship dates and will record one price for the first two units to be shipped immediately, another price for the two units to be shipped in five days, and a final price for the remaining six units. It is to be further appreciated that in addition to indicating the ship dates, the buyer interface component allows the user to change the ship dates of goods after they have been ordered.

In another aspect of the invention, the buyer interface component 310 permits the buyer to request that a good be held for a specific number of days. The specification of a hold time serves to increase the price of the good/service, since the seller must now retain the good in inventory. For example, the price can change to reflect the additional carrying costs by the supplier, such as adding 1% for every thirty day hold period. As such, if a buyer does not require the good until a later date, but wants a good at the current price, the buyer can use the buyer interface component 310 to indicate to a seller to hold the requested amount of good for a period of time indicated by the buyer. The price component 120 can update the price or price curve to the buyer, showing the additional charge for the hold time, and if the price is agreeable to the buyer, the buyer can accept the deal.

Additionally, the buyer interface component 310 is a mechanism that allows for the display an available quantity of good. Since the buyer can see the available quantity of a desired good, the buyer will know immediately that the good is available for purchase. If the buyer sees an indication that a good is not available, the buyer is able to quickly cease a search with the current seller and find another seller of the good. Additionally, the buyer may contact the seller to attempt to purchase the out of stock item. Examples of buyer options may include, but are not limited to being put on a wait list, having the seller acquire the goods from a third party, etc.

The buyer interface component 310 can include additional functionality to further aid in commerce. For instance, an icon could be available to place the order automatically—the system would then execute all orders. For example, a buyer can assemble multiple orders, and save them for submission at a more convenient time. Later, the icon can be used to submit all or part of the orders. Alternative functionalities can also be provided for the icon. For example, the buyer can click on the icon to be alerted of price changes among other options provided by supplier (e.g., special offers, changes to schedule).

It is to be further appreciated that the price component 120 can determine the price of goods in real time. As indicated above, the buyer interface component 310 allows the buyer to indicate disparate shipping dates for goods in the same order as well as allows the buyer to change the ship dates in response to changing business needs. In response to a change in the ship dates, the price component 120 updates the price of the goods in real time. For example, a buyer indicates that a total of ten units is required, but only indicates that two units ship immediately, two ship in five days, and the remainder be shipped in one month. At a later time, the buyer changes the ship dates of the order by using the buyer interface component 310 so that five units are to be shipped immediately and the rest are to be shipped in one week. As a result, the price component responds to the changes and generates and displays an updated price. Real-time updating of the price is not limited to changes in ship dates. The price component 120 can update the price in real time in response to changes in order related factors. In response to the changes in ship dates, a change ship schedule can show the goods ordered and the ship schedule. Additionally, the price component can update the price in response to a change in the change ship schedule.

It is also to be appreciated that the price component 120 can provide a range of prices and other deal criteria in response to buyer input. A buyer can indicate that he wants a quantity of goods, but the date requirements are flexible. The buyer can indicate an acceptable window of time for which the goods are to be shipped. In response to the window, the price component 120 can to generate a maximum and a minimum price corresponding to the range of desired criteria. The price component 120 can also generate a hybrid price. This hybrid price can be a price for part of the total order. It is to be appreciated that in addition to delivery date factors, the price component 120 is able to generate a maximum and minimum and hybrid price for order related factors. Thus, the buyers and sellers are able to tailor their searches for goods to their specific needs.

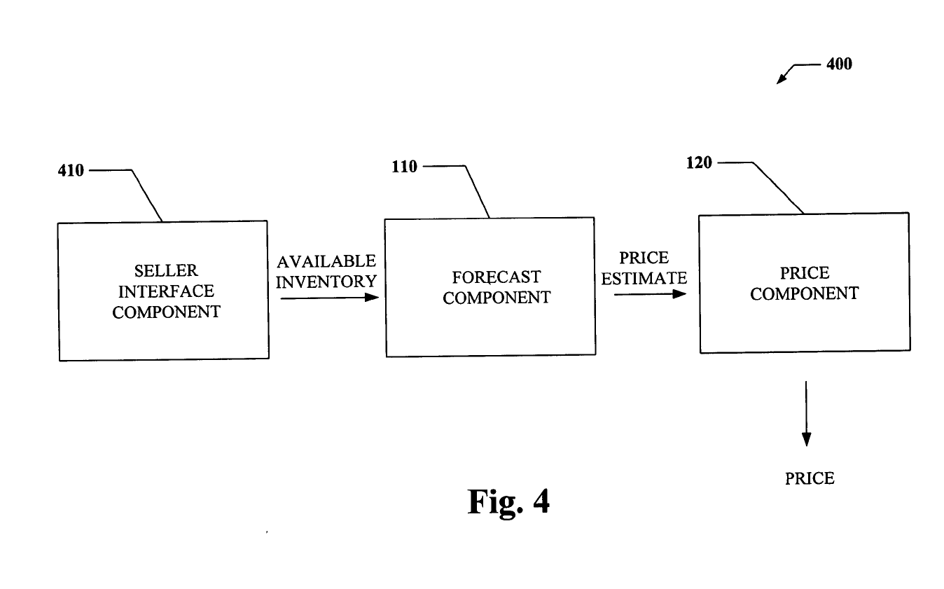

Turning now to FIG. 4, a system 400 is provided in accordance with an aspect of the subject invention that includes a forecast component 110 and a price component as previously described as well as a seller interface component 410. A seller interface component 410 of system 400 is a mechanism that allows a seller to input criteria into the forecasting component 110. The seller interface component 410 enables a seller to dynamically update the currently available inventory of a good. For example, if a seller ships five of the ten remaining goods, he can update the amount of available inventory to reflect the change. Additionally, if a buyer indicates for the seller to hold a good, the seller interface component 410 allows for updating the inventory so that other buyers can be informed of the actual number of goods available for sale.

A seller can also use the seller interface component 410 to respond to orders and change the terms of orders in response to buyer initiated changes in the order. For example, if a buyer requests a ship date change, the seller may respond by changing the terms of future orders such that the rest of the buyers must be placed online and that the customer must pay for shipping. It is to be appreciated that the seller interface component 410 is not limited to responding to changes in ship dates. Rather, the seller interface component 410 affords flexibility in the transactions.

The seller interface component can also provide a mechanism to enter special offers or other deal related information. The seller can view a list of buyers or potential buyers, determine the volume of goods or services that the buyer has purchased in the past or plans to obtain for the future, and see other buyer related activity and characteristics. From that information, the seller can then classify buyers into different levels and tailor deals, sales, offers, etc. to each classification of buyer. For example, if a buyer has purchased a high number of goods from the seller regularly for five years, that buyer may be placed in a classification that provides more advantageous offer and deal criteria than a customer that purchased a low volume of the same good or service only a small amount of times.

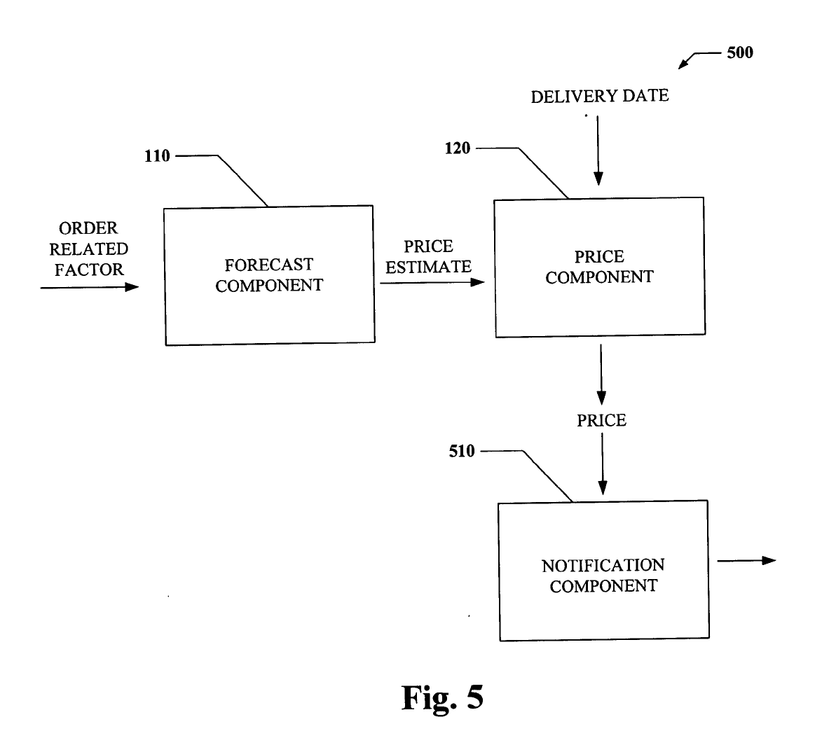

Referring now to FIG. 5, a system 500 is provided that includes a notification component 510 in addition to the previously described forecast component 110 and price component 120. Notification component 510 is a mechanism that allows notification to a buyer or seller or other interested party of a deal, offer, or terms of an offer or deal. The notification component 510 can be communicatively coupled to a price component 120 to receive a price other offer related information. The notification component can send information via many means of communication, including but not limited to computer, email, IM, blackberry, and text messaging. The notification component 510 can also generate a customer invoice that relates information notifying the buyer of the aspects of the buyer's purchase. Such aspects can include, but are not limited to, amount of the good ordered, total price of the good, hybrid price of the order, and ship date. The invoice can be issued and transmitted automatically on the completion of a sale. As a response to a change in the ship dates or order related factor, the invoice can issue reflecting the changes, as well as the associated changes in price and other factors. It is also appreciated that the notification component 510 can also be utilized to inform potential buyers of specific deals related to price or some other aspect in the transactions of goods/services.

The aforementioned systems and have been described with respect to the interaction between several components. It should be appreciated that such systems and can include those components specified therein, some of the specified components, and/or additional components. For example, a system can include forecast component, price component, aggregation component, seller interface component, buyer interface component, notification component or any combination thereof. Additionally, it should be noted that one or more components may be combined into a single component providing aggregate functionality or divided into several sub-components. The components may also interact with one or more other components not specifically described herein but known by those of skill in the art, as well as systems and components provided hereinafter.

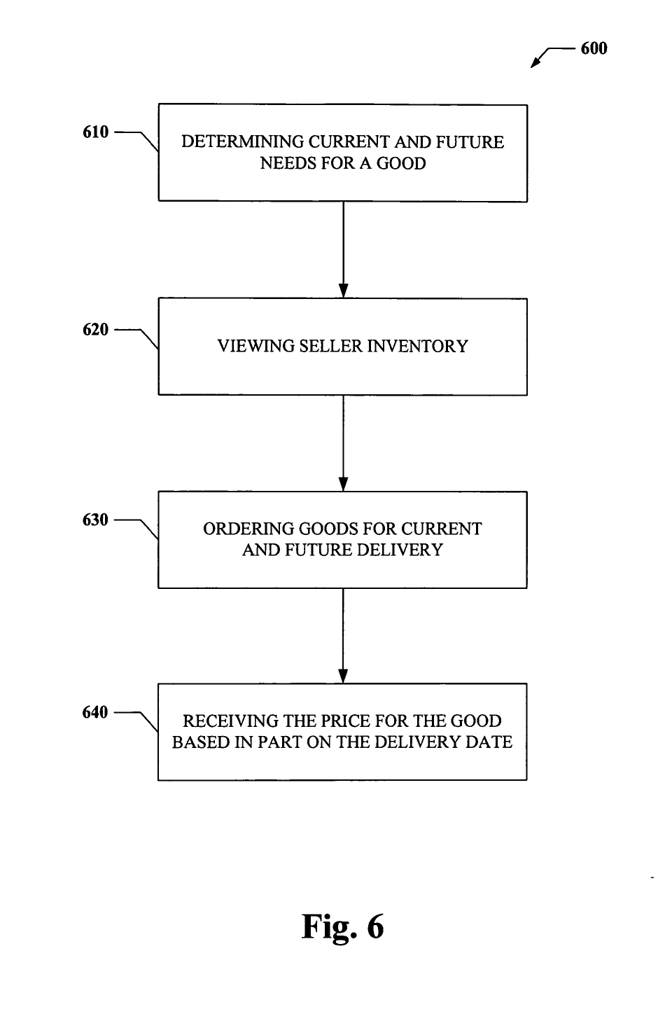

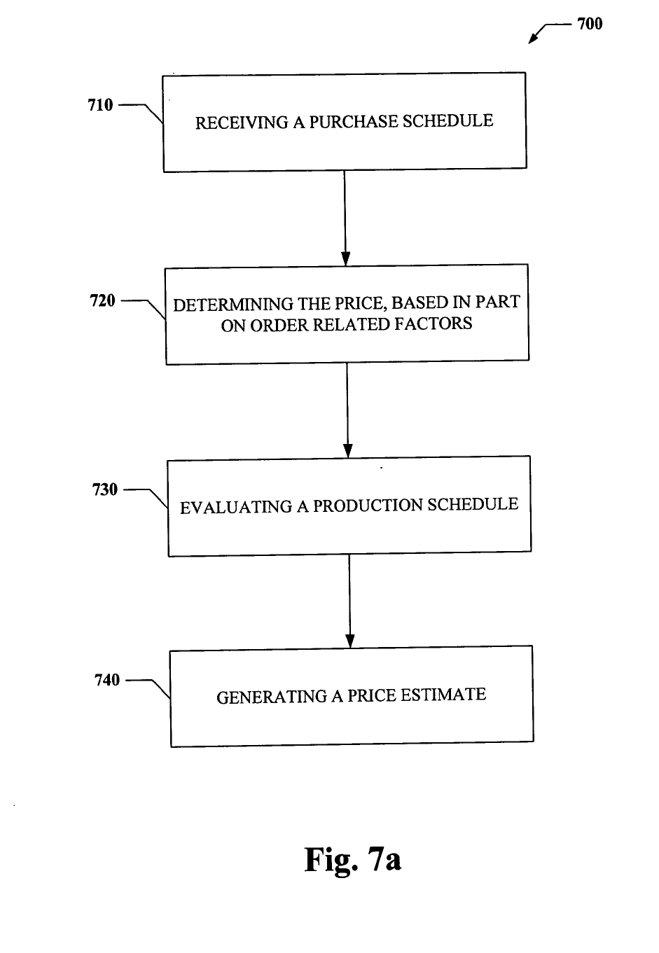

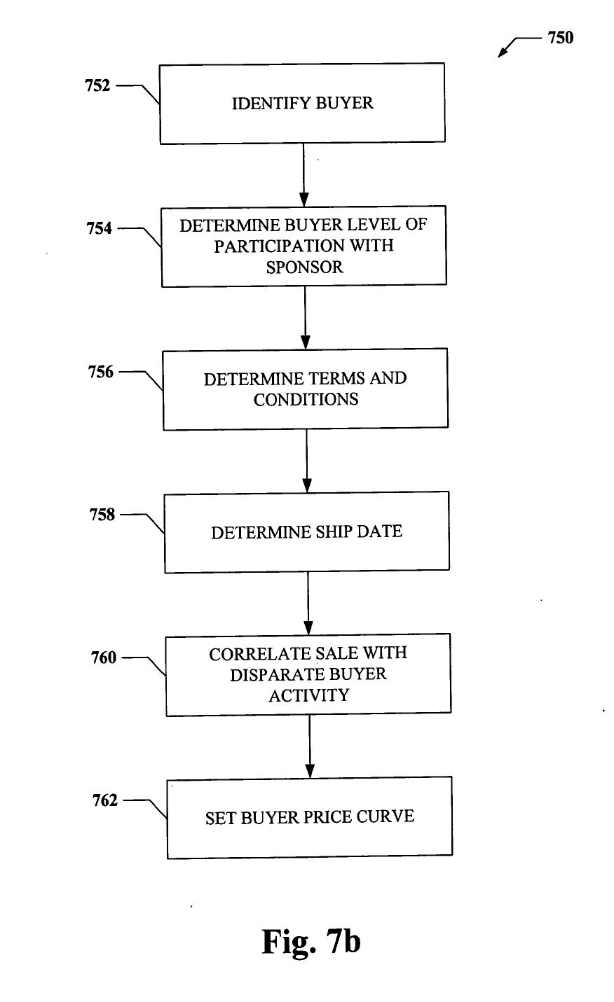

FIGS. 6, 7a, and 7b illustrate methodologies 600, 700, and 750 in accordance with the subject invention. For simplicity of explanation, the methodologies are depicted and described as a series of acts. It is to be understood and appreciated that the invention is not limited by the acts illustrated and/or by the order of acts, for example, acts can occur in various orders and/or concurrently, and with other acts not presented and described herein. Furthermore, not all illustrated acts may be required to implement the methodologies in accordance with the present invention. In addition, those skilled in the art will understand and appreciate that the methodologies could alternatively be represented as a series of interrelated states via a state diagram or events.

Referring now to FIG. 6, which illustrates a methodology 600 to provide a price for a desired good. At 610, a buyer determines the current and future needs for a particular good. Such needs can be related to production, inventory, etc. related to the buyer and can vary based on any number of factors, such as the time when the buyer determines they have a need for the good. At 620, after the buyer has determined his or her need for the good, the buyer can view the seller inventory and price for the good. It is to be appreciated that the price given by the seller for the good is dynamic and thus, subject to change based on current orders, future orders, cost of raw materials and the like. For example, if a buyer requests a ship date change, a seller can respond or change terms of terms of a purchase agreement (e.g., rest of orders must be placed online with posted ship date, customer pays for shipping, etc.)

Additionally, a seller can update the amount currently available for sale (e.g., in inventory) and once exhausted can automatically reject these requests or modifications. For instance, a buyer sees there are three of the desired goods in inventory and would like to have one released for the price showing on a price curve. The order is executed and the buyers now see two units remaining for quick ship.

At 630, the buyer orders goods for current and future delivery based on the needs determined at 610. Goods can be ordered so that delivery occurs at disparate times for different quantities of goods. For example, a buyer can order ten units but only requires two units now, two units in five days and the remainder on the posted ship date. The system allows the buyer to order all with different ship dates and will record one price for the first two units, another price for the other two unit order and finally the final price for the six units remaining. As the prices are determined based on the seller schedule and terms, the buyer's invoice will be calculated in real-time and show the hybrid price and total price for these units. At 640, the buyer receives the price for the good, based in part on the delivery date. Additionally, the buyer can also receive an invoice containing the transaction information.

FIG. 7a represents a methodology 700 of outputting a price estimate to a buyer for a desired quantity of goods. At 710, a seller receives a purchase schedule from a buyer which relates the amount of goods the buyer desired to purchase on specified dates and/or includes the desired delivery dates for such goods. The buyer interface component 310 allows the buyer to input the desired units along with the preferred ship schedule for each, for example, one unit immediately, one unit shipped in five days, two units shipped tentatively for fifteen days, or one unit on hold for thirty days. In order to provide an accurate estimate of the price per unit to the buyer, the seller can take in a plurality of factors. At 720, the seller can aggregate the desired order of the buyer with other orders for the same good. Such an aggregation can change the price the buyer will be charged based on a multitude of factors (e.g., volume of orders from disparate buyers). The seller can also consider other order related factors. At 730, the seller can evaluate their production schedule based on the quantity of goods ordered by the buyer. In this manner, the seller can plan to allocate necessary resources toward the manufacture and delivery of the goods for sale. Such planning can make the seller more efficient and thus save resources that can be utilized elsewhere by the seller. At 740, a price estimate can be output and provided to the buyer. The system can take the buyer request and automatically simulate what the prices would be: one unit shipped immediately for a price of $10; one unit shipped in five days for a price of $10−$7 depending on order related factors; two units shipped tentatively for fifteen days for a price of $10−$5 depending on order related factors; or one unit held for thirty days for a price of $10−$5+1% or some amount for holding charge.

Turning now to FIG. 7b, which shows a methodology 750 related to the setting of a price curve based on a plurality of factors related to the sale of one or more goods. At 752, a buyer is identified by the system via one of a plurality of methods. For example, a buyer can enter a deal room in order to place an order for a specific good. In order to provide the correct pricing scheme for the buyer, information relating to the buyer's past purchasing history may be needed. At 754, the buyer's history of participation with the deal room sponsor is determined. Such a history can include type of good purchased, volume of goods purchased, price history of goods, etc.

Briefly stated, a deal room is a forum for the buyer and seller communicate the purchase and sale of goods. Deal rooms will be discussed in more detail in later sections. However, it is to be appreciated that such a deal room can involve any number of technologies to facilitate interaction between a buyer and a seller such as teleconference, video conference, net meetings and the like. It is also to be appreciated that the subject invention can employ a plurality of deal rooms. In addition, such deal rooms can be private in that the buyer is only exposed to his/her own price curve(s) (e.g., and no other buyer's price curve) related to the goods the buyer is interested in purchasing from the seller. In this manner, the seller can adjust their pricing structure without danger of harming current potential business relationships with buyers which could occur if a buyer was aware of another buyer's price structure.

At 756, terms and conditions of a sale are determined between the buyer and the seller. Such terms and conditions can include: no cancellation of order, cancellation possible, tag and pull program and various payment options, for example. Also, a buyer can see a summary of the conditions available to vary the price of an order. Such a summary can include: starting price, next price, lower price, etc. Thus, a buyer can generate a plurality of “what if' scenarios to get a better understanding of how orders can achieve lower price points by changing buyer behavior. For example, “what would my combined price be if I want X slabs delivered in two weeks and Y slabs delivered in eight weeks?”

In addition, a seller can have multiple aggregation curves available at the same time. In this manner, the curves can be affected differently when presented with the same changes to the same factors. For instance, a customer A can be sent a counter offer from their seller which in turn can affect delivery of one unit of goods to two weeks and/or provide a discount per unit of goods. Customer A can then accept or reject the counter offer based on the conditions given by the seller. In this case, substantially all of the terms of the sale can be revised and such revisions can be initiated by either buyer or seller.

Alternatively, offers can be posted when the item is the least expensive. In this aspect, a buyer would not be aware of the offer for sale until the price is optimum. Additionally, a price curve may not be given; instead a listing of the product and the corresponding ship dates are included with the seller's offer.

It is to be appreciated that terms and conditions can be associated with any price curve. Such terms and conditions govern buyer and seller transactions. For instance, a seller can specify that an offer is good for a particular period of time. Additionally, a seller can specify terms and conditions that indicate that an offer may increase over time.

At 758, a desired ship date of goods is determined. Such ship date can relate to various price adjustments dependent upon the date the customer expects the product to be delivered. Such prices can increase or decrease dependent upon various seller related factors such as existing orders, production schedule, availability and cost of raw materials. For example, “what is my price with the following ship date?” (product available now); “what is my price with the following ship date?” (two weeks from now); “what is my price with the following ship date?” (8 weeks from now).

Dynamic ship dates can also be employed such that the item is simply posted to a deal room when the item is the least expensive. Furthermore, a price curve does not necessarily have to be displayed with the dynamic ship dates option. Rather, a product list and ship dates with dynamic prices can be shown.

Moreover, optimal times can be given to a buyer wherein a “best price” can be available on a specified order date. Similarly, the optimal time for shipping goods can be provided to a buyer, which can relate to a shortened lead time for delivery, discount on shipping costs and the like.

At 760, the identity of the user combined with the terms, conditions, and ship date of the sale are correlated to disparate buyer activity. Such activity could involve a disparate deal room wherein an offer is made for the same or different good as in the subject deal room. In addition, a correlation can be made between the disparate buyer history of participation with the seller. Thus, the terms of the offer, although distinct for each individual buyer can be correlated to modify such terms in the future.

At 762, the buyer price curve is set based on any number of factors above such the identity of the buyer, terms, conditions, ship date and the like. The price curve can vary as such factors change and/or remain the same based on an algorithm, program, etc. Price curves can be employed to provide a plurality of different aggregated offers for a specific good dependent on various factors, such as quantity. For instance, a buyer can enter the amount of goods and see one price curve for one slab, two slabs, three slabs, etc. If the buyer selects three slabs, he can see a price curve tied to the volume of all the people aggregating, even though the quantity ordered puts the buyer on a different curve than someone ordering one or two slabs, for example. After selecting the quantity desired, a buyer can select various desired terms and conditions related to the sale of the goods, such as:
No cancellation of order—see a slightly different curve, a discount of 2% taken from final price
Cancellation possible—see a curve that is higher, a premium of 5% charged to final price . . .
Tag and pull program for 60 days—add 3% to price
Payment option: pre-pay—same as above, net 10 terms, etc.

Each variable can reflect a different price than is shown on the curve immediately as well as potentially on all price points. An increase in price based on such above conditions can be mitigated if the buyer orders a large enough volume (e.g., three slabs ordered would then negate a surcharge on tag and pull program, or extend the program to 90 days, or any number of variables).

A buyer can see total volume ordered to date on this product (or other products)—once a minimum threshold is reached by the buyer as determined by a seller in this case, the price curves going forward adjust based on the software configuration. For instance, a buyer who has ordered fifty slabs to date now sees a lower price curve even though he in fact may be ordering the same amount as someone else on that particular order.

Another variation of this theme is a buyer who belongs to a larger organization with a larger volume than the other buyers and receiving special pricing and/or options based on their size. The cumulative total would reflect all participating organizations.

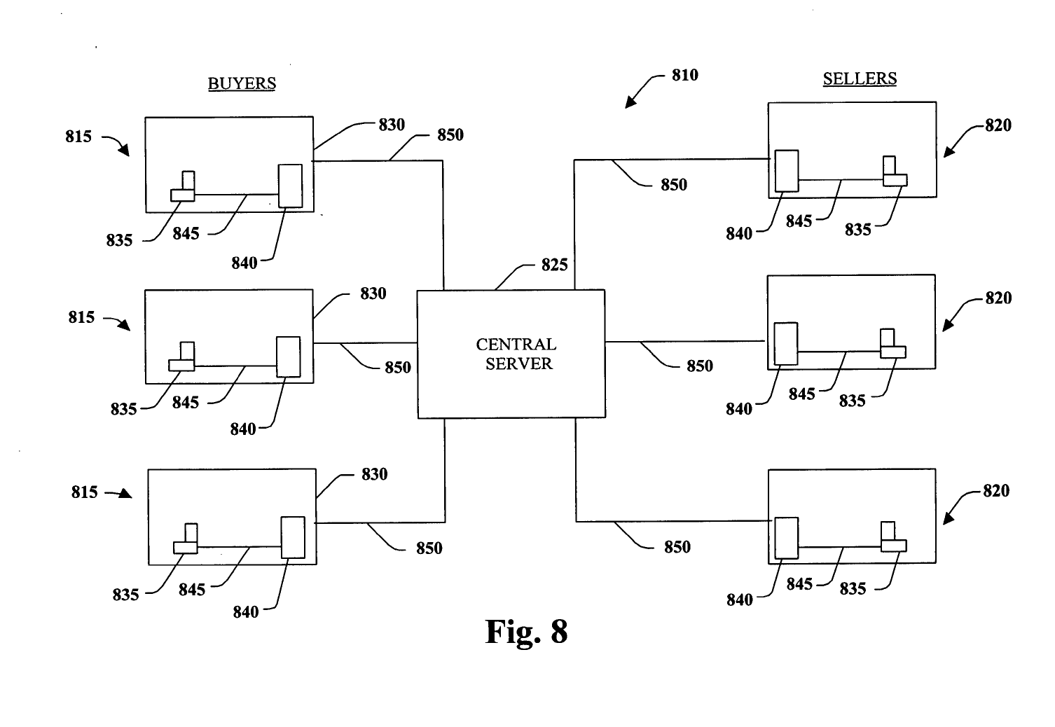

Referring to FIG. 8, a system 810 is shown in which multiple buyers 815 and sellers 820 are electronically linked via a central server 825. System 810, as well as the following description, provides a context for aspects of the subject invention. As discussed in more detail below, the central server 825 is configured to provide the buyers 815 and sellers 820 with a convenient forum in which to buy and sell goods in accordance with a multiple criteria buying and selling methodology described herein. This multiple criteria buying and selling methodology can incorporate the aforementioned systems and methodologies of the subject invention. The forum may, for example, be a pre-established Internet web page where sellers 820 are able to post product information and the buyers 815 are able to order products. The multiple criteria buying scheme calls for a seller 820 to post a number of deals for a given product, which vary according to different offering criteria defining the limits of a number of selling criteria, such as for example, price, volume, quality and delivery time. Each buyer 815 is able to enter a range of criteria that the buyer would require for a deal to be made. A list of sellers and prospective deals offered by these sellers is generated for the buyers to review. Each buyer 815 can then review the list of deals and choose a deal based on the buyer's particular needs. In this manner, each of the buyers 815 can be certain that particular thresholds have been met and also be guaranteed of completing a deal.

Each of the buyers 815 and sellers 820 may access the central server 825 in any of a variety of ways. In FIG. 8, each buyer 815 and seller 820 is shown to be part of separate establishments 830 which include one or more respective computer systems 835 and local servers 840. The computer systems 835 may, for example, be a desktop or laptop computer with a local area network (LAN) interface for communicating over a network backbone 845 to the local server 840. The local servers 840, in turn, interface with the central server 825 via a network cable 850 or the like. It will be appreciated that while system 810 depicts the computer system 835 communicating with the central server 825 via hardwired network connections, in an alternative aspect the computer system 835 may interface with the central server 825 using a modem, wireless local area and/or wide area networks, internet, etc. Further, it will be appreciated, that while the buyers 815 and sellers 820 are shown to communicate with the central server 825 via different computer systems 835, it will be appreciated that the buyers 815 and/or sellers 820 may access the central server 825 from the same computer system 825.

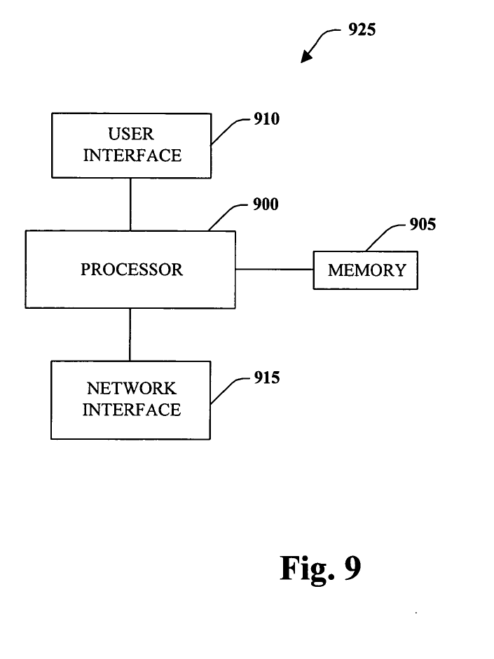

FIG. 9 illustrates a block diagram of the hardware components of the central server 825 is shown. In particular, the central server 825 includes a central processor 900 for performing the various functions described herein. A memory 905 is coupled to the processor 100 and stores operating code and other data associated with the operations of the central server 825. A user interface 910 is also coupled to the processor 900 and provides an interface through which the central server 825 may be directly programmed or accessed. The user interface 910 may, for example, be an alphanumeric keyboard and mouse. A network interface 915 coupled to the processor 100 provides multiple connections for transceiving information with buyers 815 and sellers 820 over the network cables 850.

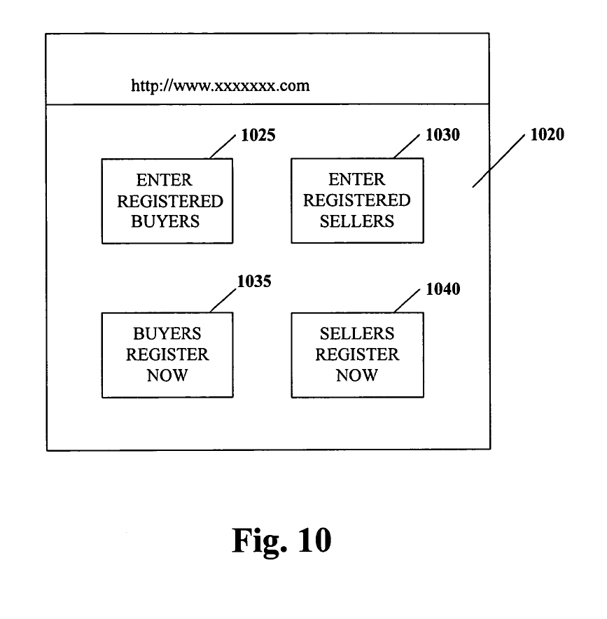

Turning now to FIG. 10, an exemplary Internet web page 1020 which provides buyers 815 and sellers 820 with access to a forum for conducting business using the multiple criteria buying methodology described in detail below, is shown. The web page 1020 is shown to include hyperlinks for handling both registered and un-registered buyers and sellers of products. For example, as shown in FIG. 10, registered buyers may select a hyperlink to a registered buyer login screen via hyperlink 1025 while non-registered buyers may select a hyperlink to a non-registered buyer registration screen via hyperlink 1035. Similarly, registered sellers may select a hyperlink to a registered seller login screen via hyperlink 1030, while non-registered sellers may select a hyperlink to a non-registered seller registration screen via hyperlink 1040. While the web page illustrates separate hyperlinks for buyers and sellers, it will be appreciated that such hyperlinks could alternatively be combined and the status of buyer or seller could be determined during a later stage in the login procedure.

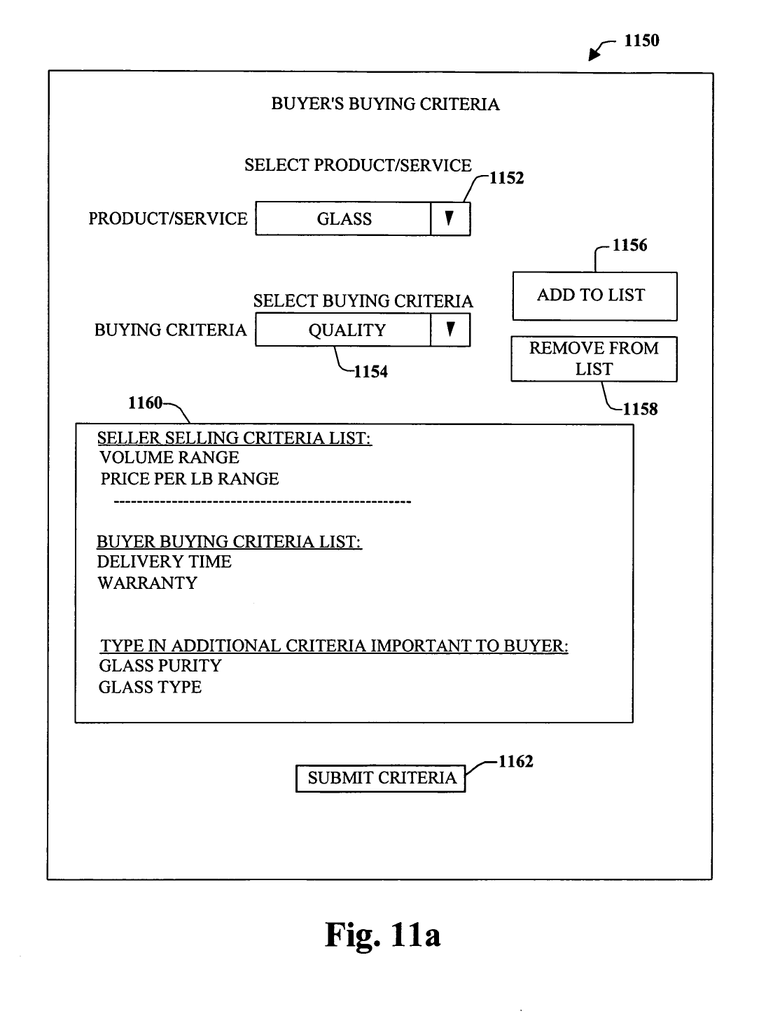

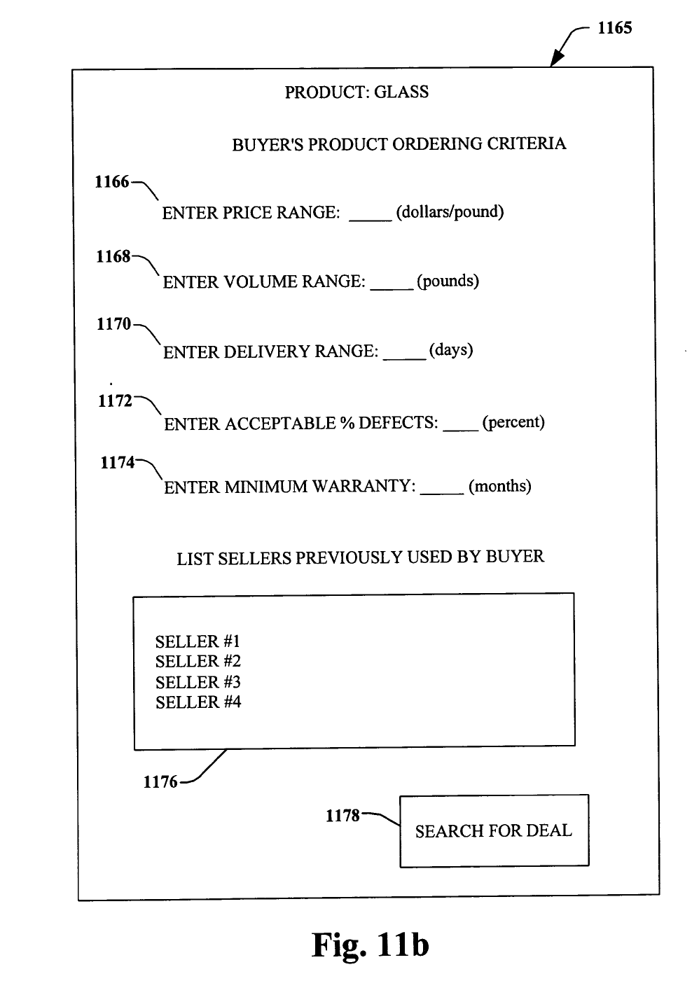

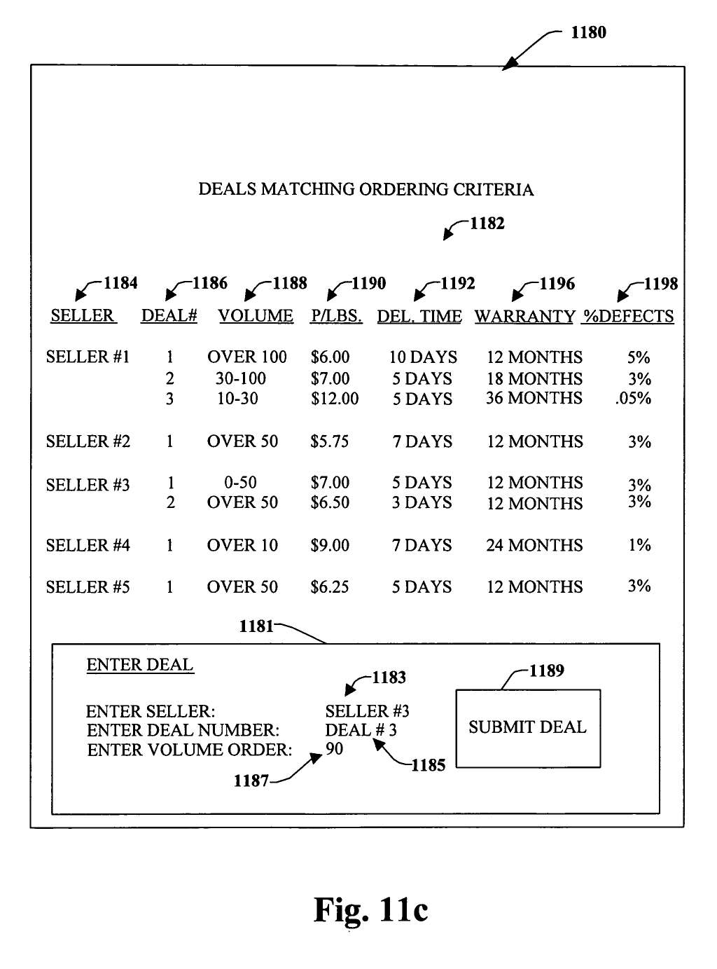

Turning now to FIG. 11a, in accordance with one aspect of the invention, registered buyers 815 enter several product buying criteria into a Buyer's Buying Criteria input page 1150. The buyer 815 selects a product or service from a list in a scroll down menu 1152. It should be appreciated that the list on the scroll down menu 152 could include any number of related or non-related goods and services only limited by the size of a database used in accordance with the subject invention. Upon selecting a product or service (e.g., glass) from the scroll down menu 1152, a list of seller criteria automatically appears in a window 1160. The list of seller criteria appearing in the window 1160 is the minimum inputs to be provided by the buyer to obtain a deal listing. These minimum inputs are decided by the class of sellers selling the individual product or service and/or decided by the system administrator of the system. The buyer 815 can then begin adding buyer buying criteria by selecting the criteria from a scroll down list 1154, and clicking on an Add to List button 1156 with a computer mouse (not shown), for example. If the buyer 815 desires to remove a buyer buying criteria, it is only necessary to highlight the criteria in the window 1160 and click on a Remove from List button 1158. Once the list is completed, the buyer 815 may add additional criteria considered by the buyer to be important, but not listed in the selection of choices. These additional criteria will not be used by the buyer in this particular deal search, but will be provided to the sellers, so that they can be alerted of these additional criteria important to the buyer. The seller may opt to add to the selectable choices these additional buyer's buying criteria at a later time. Once the complete custom buyer buying criteria list is completed, the buyer can click on the Submit Criteria button 1162 for submission of the buyer's buying criteria to build a Buyer's Product Ordering Criteria input screen 1165, as illustrated in FIG. 11b.

Turning now to FIG. 11b, in accordance with one aspect of the subject invention, registered buyers 815 enter several product ordering criteria that would be acceptable to the buyer 815 on the Buyer's Product Ordering Criteria input screen 1165. In this particular example, the buyer 815 is looking to purchase raw glass by the pound, however, many different types of products and services could be purchased/sold using the invention. The buyer's ordering criteria of this example includes: price range 1166 in dollars per pound; volume range 168 in number of pounds; delivery range 1170 in days; the acceptable percentage of defects 1172 in percent; and the minimum required warranty 1174 in months. The buyer 815 can then list the names of the sellers 820 in the window 1176 that the buyer 815 has bought products from previously, so that the buyer 815 can be entitled to any good customer or multi-purchase discounts offered by the sellers 820. Once the buying order criteria is entered, the buyer can search for deals by clicking on the Search for Deal button 1178 on the computer screen using the computer's mouse. The subject invention then utilizes a search engine to search through a database of deals offered by various sellers of the product, and provides an output of those deals to the buyer that matches the buyer's ordering criteria by outputting a list of these deals on a Deal Matching Ordering Criteria output page 1180, as shown in FIG. 11c.

Turning now to FIG. 11c, in accordance with one aspect of the invention, registered sellers 820 set up a variety of deals 1182 by which registered buyers 815 are able to order products. As will be discussed in more detail below, the deals 1182 of the aspect are set up to display the following information which is input from the seller 820 and/or calculated by the processor 900 of the central processor 25 according to the deal 1182, which includes: a seller name 1184; a deal number 1186; a volume ordering range required 1188 to obtain a current price/pound level 1190; an expected delivery time 1192; a warranty period 1196; and a percentage of defects 1198 of the product the buyer 815 can expect to receive in a given order. Based on such information, buyers 815 can make an informed decision as to whether they desire to commit to an order on a particular deal based on the criteria that is important to that particular buyer. If a buyer 815 desires to place an order, the buyer 815 inputs a deal number 1185 and a volume order 1187. The buyer 815 then clicks on the Submit Deal button 189 with a mouse pointer, for example, on the computer display and the deal is finalized.

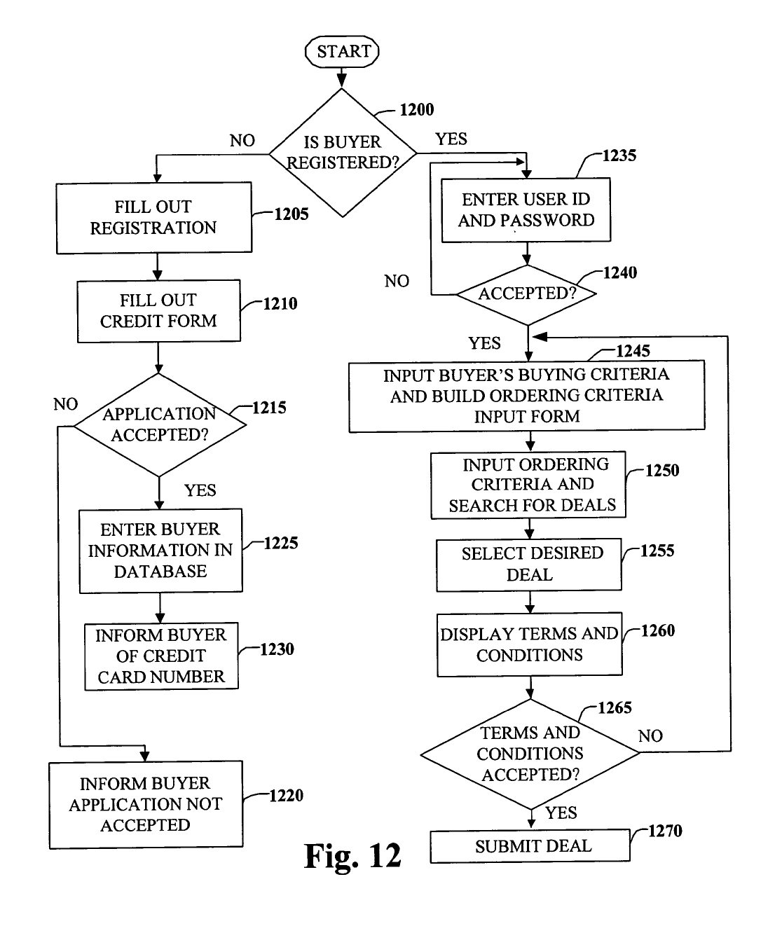

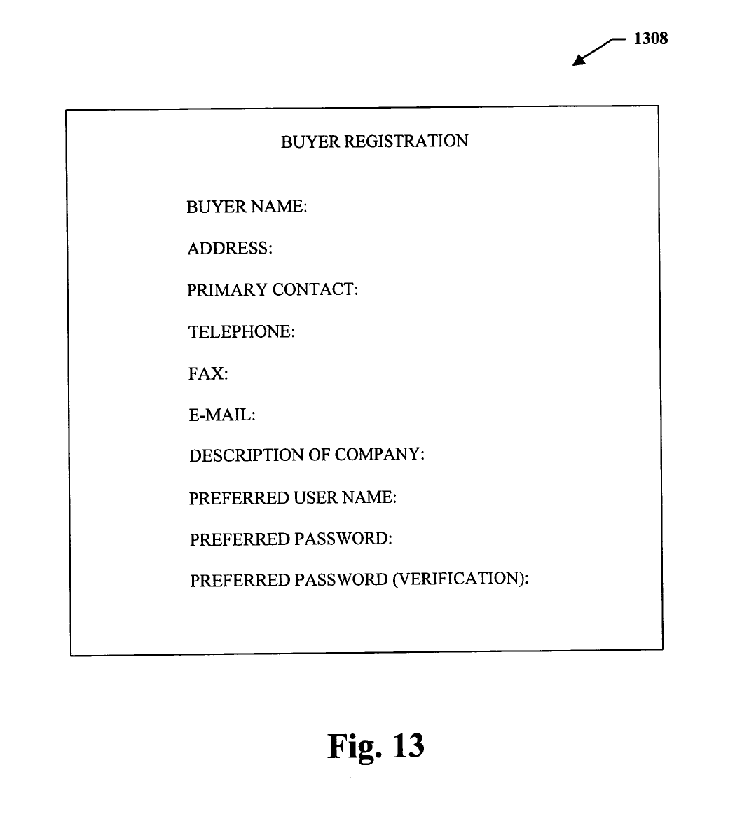

Turning now to FIG. 12, the general actions taken by a buyer 815 entering the web page 1150 is shown. More particularly, at reference numeral 1200 it is initially determined whether a buyer 815 is registered. If the buyer 815 is not registered, the buyer 815 selects hyperlink 1035 (FIG. 10) and proceeds to 1205. At 1205 the processor 900 of the central server 825 requests that the buyer 815 fill out a registration form. For example, the buyer 815 is requested to fill out a registration form 1308 such as that shown in FIG. 13. In this example, the registration form 1308 requests that the buyer 815 enter the following information: buyer name; address; primary contact person; phone; fax; e-mail; short description of company; preferred login user name; and preferred password. With respect to the user name and password, the processor 900 is configured to determine whether the selected user name and password combination are available and, if not, to prompt the buyer 815 to enter a new user name and password until an available combination is selected.

At 1210 (FIG. 12), the buyer is requested to fill out a credit card application so that purchases made on the web site may be immediately approved. The credit card registration and approval process may be accomplished via a hyperlink to one of various electronic credit card approval agencies which check the buyer's credit rating and set up a merchant account with a line of credit. For example, an electronic credit card approval agency which may be used in conjunction with the subject invention can be found on the Internet at http://www.interent-ecommerce.com, for example. At reference 1215, the processor 900 determines if the credit card application has been approved by the electronic credit card approval agency. If the credit card application has not been approved, the processor 900 proceeds to step 1220 where a message is sent back to the buyer 815 indicating regret that they have not been approved for a line of credit and therefore have not successfully completed the registration process. At 1220, a customer service telephone number also is provided to the buyer 815 in case the buyer has questions and/or desires to pursue registration further.

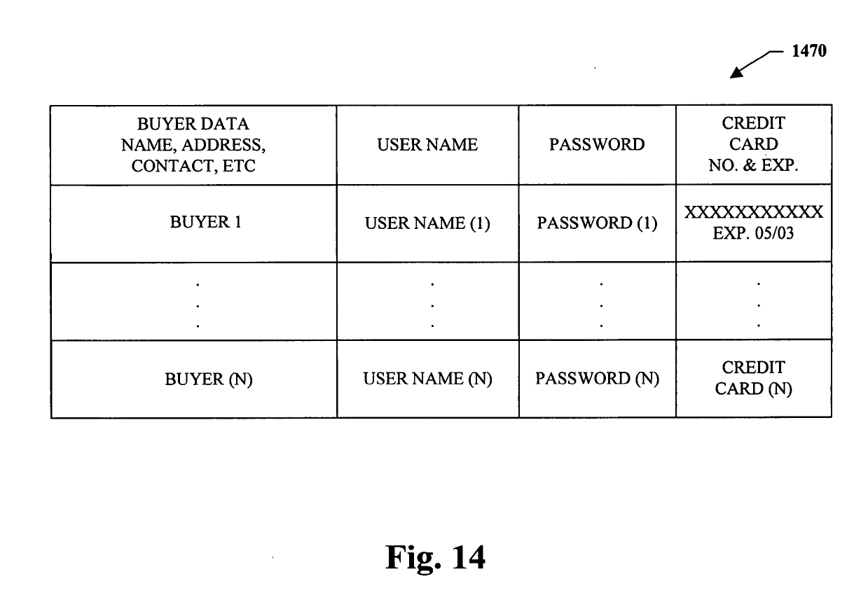

If at reference numeral 1215, the processor 900 is informed that the buyer 815 has been provided a line of credit and a credit card number has been issued, the processor 900 proceeds to 1225. At 1225 the buyer information from the registration form 208 and the newly issued credit card number are stored in a buyer database 1470 (FIG. 14) in the memory 105 of the processor 25 (FIG. 9). At 1230, the processor 900 is configured to provide the buyer 815 with the newly issued credit card number so that the buyer 815 is able to purchase products and/or services. Furthermore, the processor 900 is configured to provide a report to the system administrator who then mails a confirmation copy of the buyer's information stored in the buyer's database to the buyer 815. This completes the buyer's registration process.

Continuing to refer to FIG. 12, if at 1200, a buyer has already registered, the buyer 815 may login as a registered user by selecting the registered user hyperlink 1025 (FIG. 10). Once selected, the processor 900, at 1235, prompts the buyer 815 to enter a user ID and password. Upon entry of such information, the processor 900 at 1240 verifies the user ID and password with those stored in the buyer database 1470 (FIG. 14). If the user ID and password entered by the buyer 815 does not match any entry in the buyer database 1470, the processor 900 at 1240 returns to that act at 1235 for re-entry of such information. If, however, at 1240, a valid user ID and password are entered, the processor 900 proceeds to 1245.

At 1245, the processor 900 provides the buyer 815 with a buyer's buying criteria input screen where the buyer 815 is able to enter a variety of buying criteria important to that particular buyer 815. The buyer 815 selects a plurality of buying criteria and submits the criteria, so that the system can build an input ordering criteria form. At 1250, the buyer 815 enters the ordering criteria that is acceptable to the buyer in the input ordering criteria form, and then submits this criteria causing the system search engine to match the ordering criteria with a list of seller deals in a seller deal database. The search engine then lists the deals matching the buyer's buying and ordering criteria. As discussed above, the deals 1182 provided to the buyer 815 provide the buyer 815 with information regarding the sale of a particular product such as, for example, the volume range to get a particular price per pound, the delivery time, the warranty period and the percentage of defects in each order that a buyer can expect. In order to allow a buyer to quickly find deals 1182 of interest, the processor 900 at 1245 provides the buyer 815 with the input Buyer's Buying Criteria input screen 1150, so that active deals 1182 of interest may be found.

Once a search is completed, the buyer 815 at 1255 is able to select a desired deal 1182 from the results obtained. For example, the buyer 815 may choose a desired deal because it has a faster delivery time than the other deals. The buyer 815 may choose a deal because it has a low percentage of defects in the goods, or has a longer warranty than other goods. Regardless of the deal, the buyer 815 may choose, the buyer 815 can make an informed decision based on a variety of buying criteria. If the buyer 815 is unsatisfied with the search results or simply desires to re-perform the search, the buyer 815 at any time is able to return back to a previous screen selecting the “back” function available using an Internet browser such as, for example, Microsoft Internet Explorer, Netscape, etc. Additionally, a hyperlink to various screens, such as the search screen, preferably is provided on each web page.

Upon selecting a deal 1182, the processor 900 at 1260 displays a page of standard terms and conditions to which the buyer 815 must agree at 1265 prior to completing the deal. The terms and conditions relate to the terms governing the sale of the product or service according to which both the buyer and seller are willing to conduct business. If the terms and conditions are not accepted, the processor 900 returns the buyer 815 to step 1245, so that another deal 1182 may be selected and/or another search may be performed. If, however, at 260 the terms and conditions are accepted, the processor 900 proceeds completes the deal at 1270.

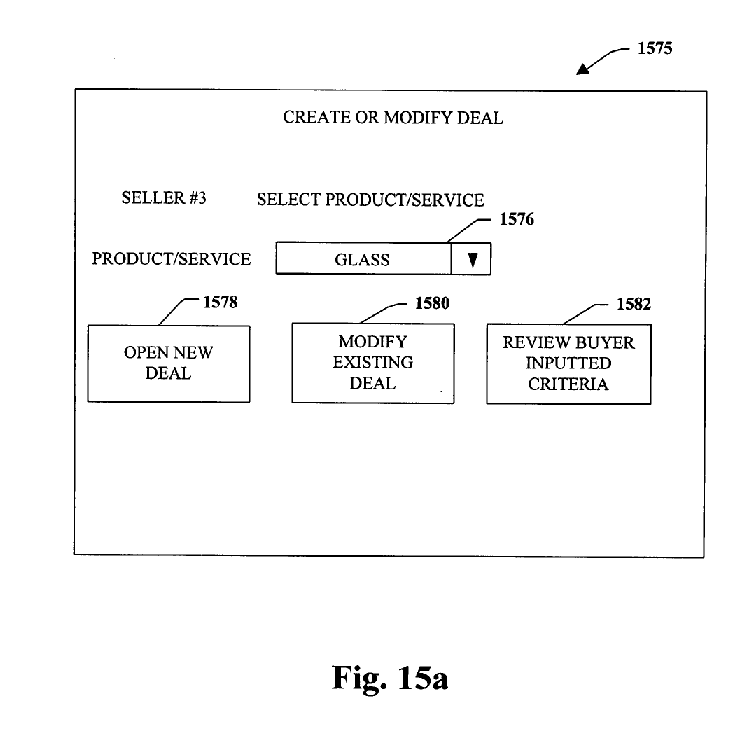

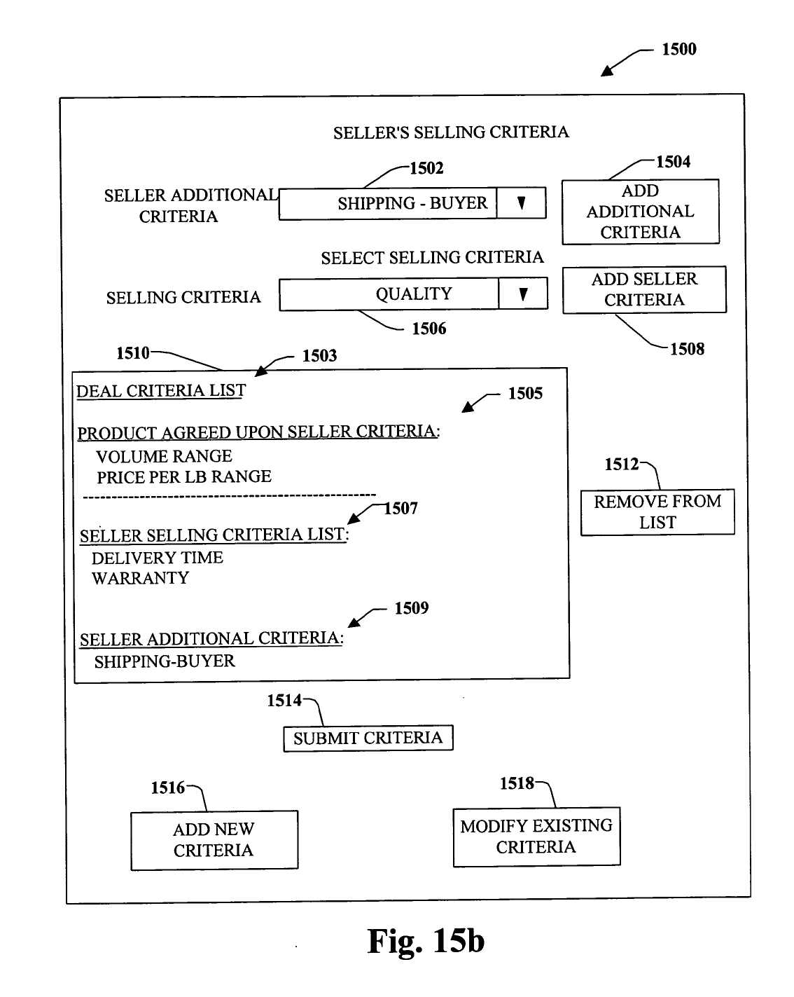

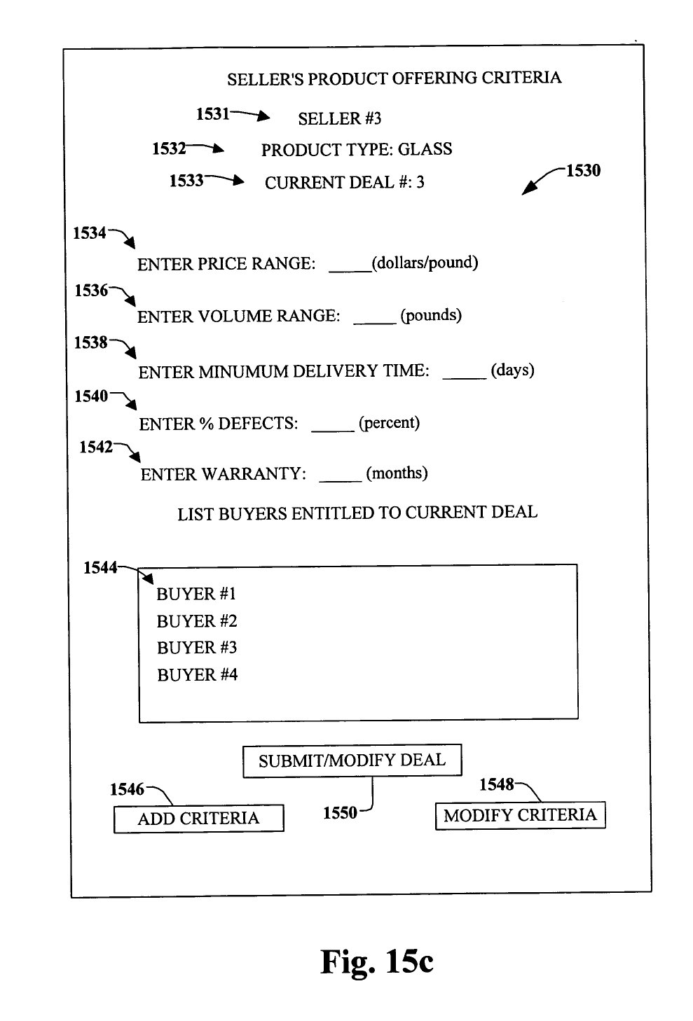

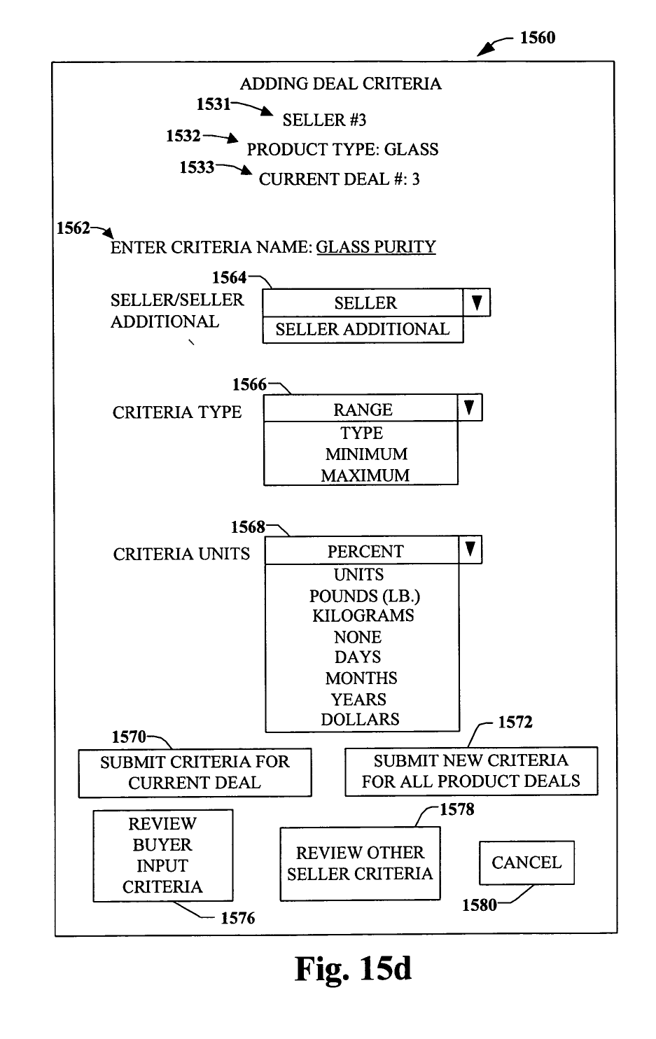

Turning now to FIG. 15a, in accordance with one aspect of the subject invention, registered sellers 820 enter into a Create or Modify Deal screen 1575. The seller 820 can choose a product or service from the product/service scroll down menu 1576 and choose to either click on an Open New Deal button 278, a Modify Existing Deal button 1580 or a Review Buyer Inputted Criteria button 1582. If the buyer selects the Review Buyer Inputted Criteria button 1582, the seller will be provided with a list of buyer buying criteria manually inputted by the buyers 815 into the window 1160 of FIG. 11a. This allows the sellers 820 to review criteria important to their buyers, of which the sellers were not aware. If a seller 820 chooses to click on the Open New Deal button 1578, the seller 820 will enter into a Seller's Product Selling Criteria input screen 1500, as illustrated in FIG. 15b. If the seller 820 chooses to click on the Modify Existing Deal button 1580, the seller 820 will enter into a Seller's Product Offering Criteria input screen 330, as illustrated in FIG. 15c and will be prompted to enter a deal number, which causes the ordering criteria of the chosen deal number to be editable in the input screen.

Referring to FIG. 15b illustrating the Seller's Selling Criteria input screen 1500, the seller 820 can begin building a new deal by first selecting a number of seller additional criteria, and seller criteria from a list in a scroll down menu 1502 and a list in scroll down menu 1506, respectively. The seller can click on the Add Seller Additional Criteria button 1504 for adding seller additional criteria from the scroll down menu 1502 into a window 1510 containing a deal criteria list 1503. The deal criteria list 1503 includes a first portion listing the Product Agreed upon Seller Criteria 1505, decided by the group of sellers for a particular product/service and/or the system administrator, a second portion which is the seller criteria list 1507 and a third portion which is the seller additional criteria list 1509. It should be noted that the criteria in the seller additional criteria list is not a mandatory criteria for the buyer when the buyer is inputting the buyer's buying criteria at 1245 of FIG. 12, but is listed in the terms and condition step 1265 after a deal is chosen by the buyer. The seller can add additional seller criteria by selecting the criteria from the scroll down bar 1506 and clicking on the Add Seller Criteria button 1508. The seller can remove any of the criteria from the overall criteria list, except for the Product Agreed upon Seller Criteria, by highlighting the selection with the computer mouse and clicking on a Remove from List button 1512. The seller 820 can add new selling criteria by clicking on a hyperlink 1516 labeled Add New Criteria sending the seller 820 to an Adding and Modifying Deal Criteria screen 1560, illustrated in FIG. 15d. The seller can modify current criteria by highlighting the criteria in window 1510 and clicking on a hyperlink 1518 labeled Modify Existing Criteria sending the seller to the Adding and Modifying Deal Criteria screen 1560 of FIG. 15d with the criteria information defaulting to the highlighted criteria for modification therefrom.

Referring now to FIG. 15c, once the criteria is selected and submitted, the system generates the Seller's Product Offering Criteria input screen 1530. A seller number 1531, a product type 1532 and a current deal number 1533 are automatically generated at the top of input screen 1530. The seller 820 can enter offering criteria relating to the seller's product for a particular deal. The seller's offering criteria of this example includes: price 1534 in dollars per pound; volume range 1536 in the number of pounds; delivery time 1538 in days; the percent of defects 1540 in percent; and the warranty 1542 in months. The seller 820 can then list the names of the buyers 815 in a window 1544 that the deal is being offered or type in the term “All” if the offer is open to any buyer. Once the seller offering criteria is entered, the seller 820 can submit the deal by clicking on a Submit/Modify Deal button 1550 on the computer screen by using the computer's mouse. The invention then creates a record of the deal in a database of deals offered by various sellers 820 of the product, so that deals which seller's offering criteria match the buyer's ordering criteria can be outputted to the buyer 815 in a list of deals on the Deals Matching Ordering Criteria output page 1180, as shown in FIG. 11c.

Referring now to FIG. 15d, the Adding Deal Criteria input screen 1560 will be described. The seller number 1531, the product type 1532 and the current deal number 1533 are automatically generated at the top of input screen 1560. The seller 820 can enter a criteria name in the Enter Criteria Name box 1562. The seller can then choose whether the criteria is a seller criteria type or a seller additional criteria type from a first scroll down menu 1564. The seller 820 can choose a criteria type from a second scroll down menu 1566 and the criteria units in a third scroll down menu 1568. The seller can submit the new criteria for the current deal by clicking on the Submit New Criteria for Current Deal button 1570 or add the new criteria for all the product deals by clicking on the Submit New Criteria for All Product Deals button 1572. The seller 820 may at any time review the buyer inputted criteria submitted by the buyer 815 that is not in any of the seller's deals by clicking on the Review Buyer Inputted Criteria button 1576. The seller 820 can review this list to determine whether the seller 820 would like to add the criteria to the current deal or all deals to ensure that they are in accord with buyer needs. The seller 820 may also review the criteria that are offered by other sellers, but not the current seller, by clicking on a Review Other Seller Criteria button 1578. This will help the seller keep current on what the other seller's selling criteria are being utilized for matching to the buyer's buying criteria to satisfy the current market demands.

If the seller would like to return to the Create or Modify Deal screen 1575 the seller 820 can click on the Cancel button 1580, at any time. Furthermore, if the seller 820 simply desires to re-perform the search, the seller 820 at any time is able to return back to a previous screen selecting the “back” function available using an Internet browser such as, for example, Microsoft Internet Explorer, Netscape, etc. Additionally, a hyperlink to various screens, such as the search screen, preferably is provided on each web page.

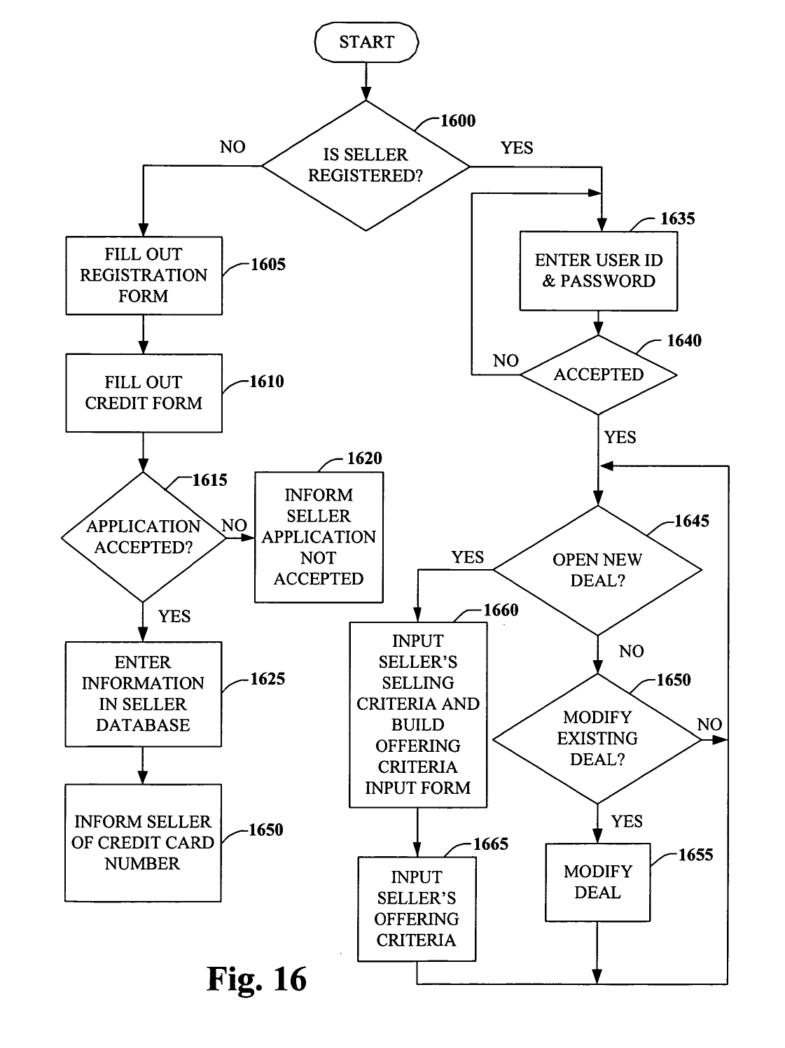

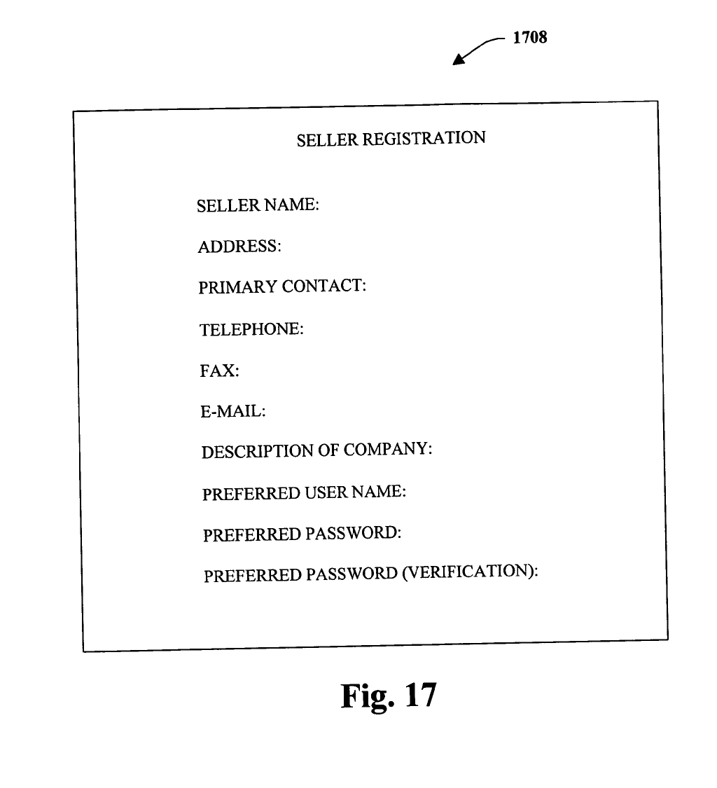

Proceeding now to FIG. 16, the operations of the processor 900 of the central server 825 in handling sellers 820 is depicted. In particular, the processor 900 at 1600 initially determines whether a seller 820 is registered based on which hyperlink 1030, 1040 (FIG. 10) the seller 820 selects. If the seller 820 selects hyperlink 1040 indicating the seller is not registered, the processor 900 proceeds to step 1605. At 1605, the processor 900 provides the seller 820 with a seller's registration form 1708 (FIG. 17) to fill out. The registration form 1708 is similar to the registration form 1308 for the buyer 820 and allows the seller 820 to select a preferred user ID and password. Once completed, the processor 900 proceeds to 1610 where the seller 820 is requested to submit a credit card application so that all costs and fees associated with conducting business may be directly billed to the seller's credit card. As discussed above, the credit card approval process may occur by a third party vendor accessible via a hyperlink.

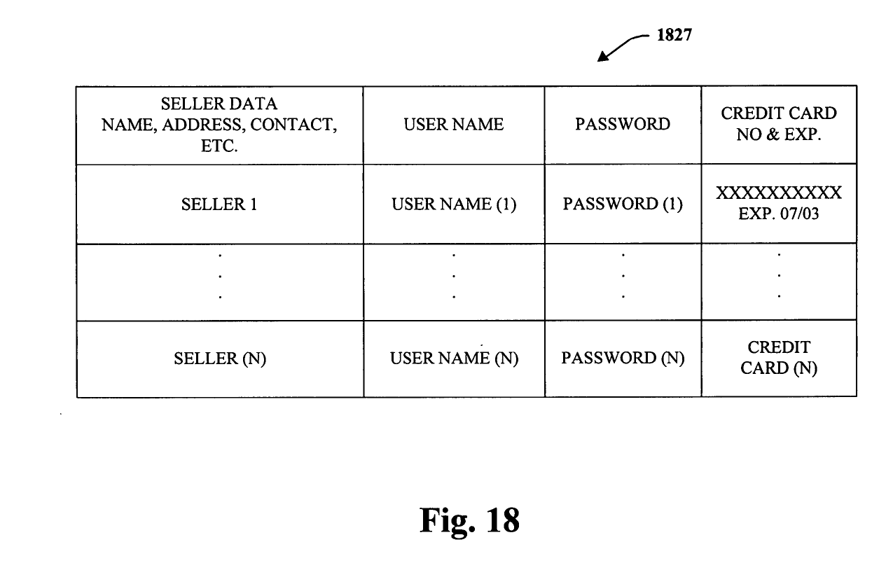

Once the credit card application is submitted by the seller 820, the processor 900 proceeds to step 1615 where the processor 900 determines if the credit card application has been approved. If the credit card application has not been approved, the processor 900 proceeds to step 1620 where the seller 820 is informed that their credit card application has not been approved and the seller 820 is provided with a customer-service telephone number so that the seller 820 may optionally set up the account in a different fashion. If, however, at 1615 the credit card application is accepted, the processor 900 proceeds to step 1625 where the seller information is stored in a seller database 1827 (FIG. 18). Finally, at 1630, the processor 900 is configured to provide the seller 820 with the newly issued credit card number so that the seller 820 is able to open deals. Further, the processor 900 is configured to provide a report to a system. administrator who then mails a confirmation copy of the seller's information stored in the seller's database to the seller 820. This completes the seller's registration process.

Continuing with FIG. 16, if at 1600 a seller has already registered, the seller 820 may login as a registered user by selecting the registered user hyperlink 1030 (FIG. 10). Once selected, the processor 900, at 1635 prompts the seller 820 to enter their user ID and password. Upon input of the user ID and password, the processor 900 proceeds to step 1640 where the processor 900 verifies a valid user ID and password have been entered by comparison with the information stored in the seller database 1827 (FIG. 18). If the user ID and password entered by the seller 820 does not match any entry in the seller database 1827, the processor 900 at 1640 returns to 1635 for re-entry of such information. If, however, at 1640, a valid user ID and password are entered, the processor 900 proceeds to 1645.

Upon successful entry of a user ID and password, the seller 820 is provided with a seller option screen 1575 as shown in FIG. 15a. For example, the seller 820 may decide to open a new deal 1182 or the seller 820 may decide to view a current deal 1182 for one of a number of goods or services offered by the seller 820 or review a list of buyer inputted criteria. Accordingly, if at 1645, the processor 900 determines that the seller 820 desires to open new deal 1182 for a selected product, the processor 900 proceeds to 1660.

At 1660, the processor 900 requests that the seller 820 enter the seller's selling criteria, so that the system can build a seller's product offering criteria input screen, at 1665. For example, at 1660 the product agreed upon seller criteria is the volume range of the order and the price per pound of the order, the seller's selling criteria includes the delivery time and warranty with quality to be added next, and the seller additional criteria is that the buyer pay the cost of shipping the goods. As discussed above, the processor 900 utilizes the information input from the seller 820 to display a seller's product ordering input form 1530.

At 1665, the processor 900 requests that the seller enter the limits associated with the seller's selling criteria chosen at 1660, and the list of buyer's entitled to be offered the subject deal. The information is entered and submitted to form a deal. The processor 900 uses this information to match buying and ordering criteria of the buyer with selling and offering criteria of the seller, so that deals can be completed in an expedited manner.

Continuing to refer to FIG. 16, if at reference numeral 1645, the seller 820 has not selected to open a new deal, the processor 900 determines at 1650 whether the seller 820 has decided to modify an existing deal 1182. In the aspect of the invention, the seller 820 is limited to modify only those deals which they have opened. Accordingly, if the processor 900 determines that the seller desires to modify a deal 1182, the processor 900 provides the seller 820 with a list of deals 180 which the seller has opened. Upon selection of one of the deals 1182, the processor 900 proceeds to step 1655 where the deal 1182 is displayed to the seller 820. If a deal 1182 is not entered at 1650, or following steps 1655 and 1665, the processor 900 returns to step 1645.

Additional and/or Alternative Aspects of the Subject Invention

### I. Seller Sponsored Deal Room, Buyer Sponsored Deal Room, and Buyer/Seller.

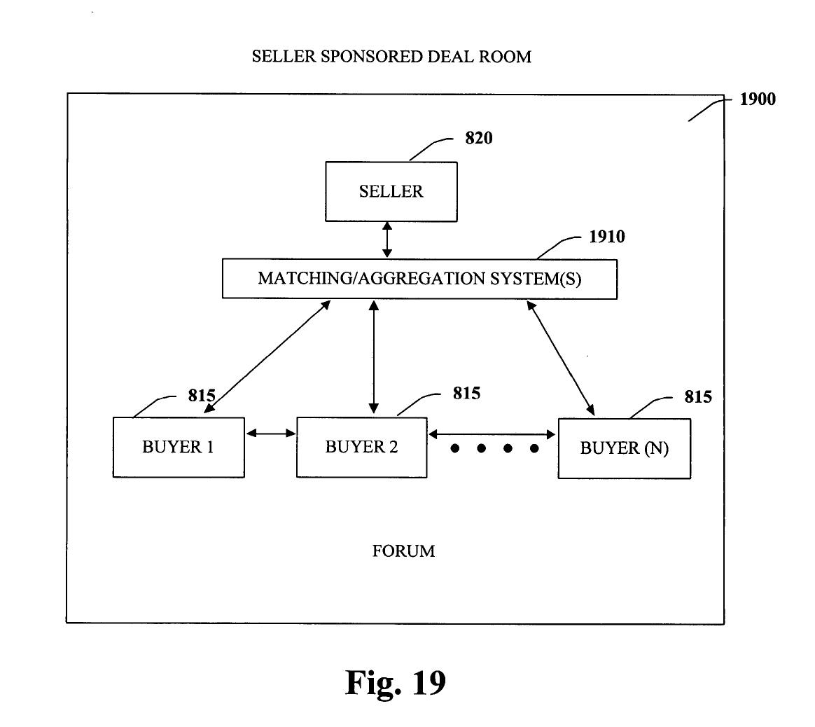

The invention has been largely described within the context of a seller sponsored deal room, as shown in FIG. 19. In Seller Sponsored Deal Room 1900 the seller 820 admits a buyer 815 or multiple buyers (or potential buyer and potential buyers) to a deal room where a certain price curve has been assigned. The buyers 815 can be invited based on their past dealings with the seller or other related factors. The buyers 815 can input orders into the Matching/Aggregation System(s) 1910. The deals may be reviewed by the seller 820, and aggregated into future price curves, production schedules, and other useful systems.

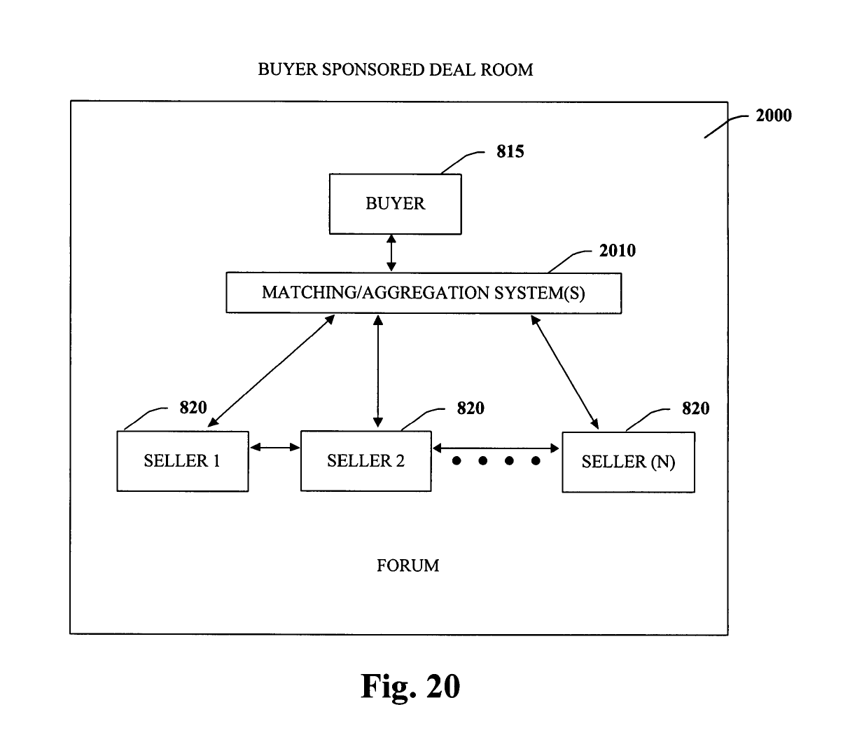

Turning now to FIG. 20, even though deal rooms discussed thus far have allowed for the sponsor to be a seller, it is to be appreciated that the invention allows for a plurality of buyer sponsored deal rooms 2000. A buyer 815 or buyers may sponsor a deal room to aggregate purchasing goods/services from a plurality of sellers 820. A buyer 815 may invite a seller 820 or group of sellers into the buyer sponsored deal room 2000. The Buyer Sponsored Deal Room 2000 can contain criteria for the terms of a deal for a specific good or service. The sellers 820 can then reply to the invitation to deal. The replies can be input into a Matching/Aggregation System(s) 2010 to adjust price curves, update production schedules, etc.

For example, a large corporate buyer may employ the subject invention to create a deal room where a plurality of sellers may assemble to aggregate selling of specific goods and/or services that the buyer desires. Such a transaction facilitates the buyer satisfying purchase requirements in one forum and to coordinate delivery of goods and/or services. Furthermore, such a system facilitates sellers making sales to the buyer. Because the sellers 820 are able to aggregate, a large corporate buyer 815 can do business with the seller. Lacking such aggregate buying and selling, the large corporate buyer may not have previously dealt with the individual seller 820 due to the seller's 820 insufficient capacity to fulfill all the buyer's 815 needs. The subject specification describes exemplary systems and interfaces for implementing the subject invention, and therefore further discussion thereto is omitted for sake of brevity. However, it is to be appreciated that one skilled in the art based on the above discussion regarding seller sponsored deal rooms/transactions could apply such teachings to implement the aforementioned buyer sponsored deal room/transaction.

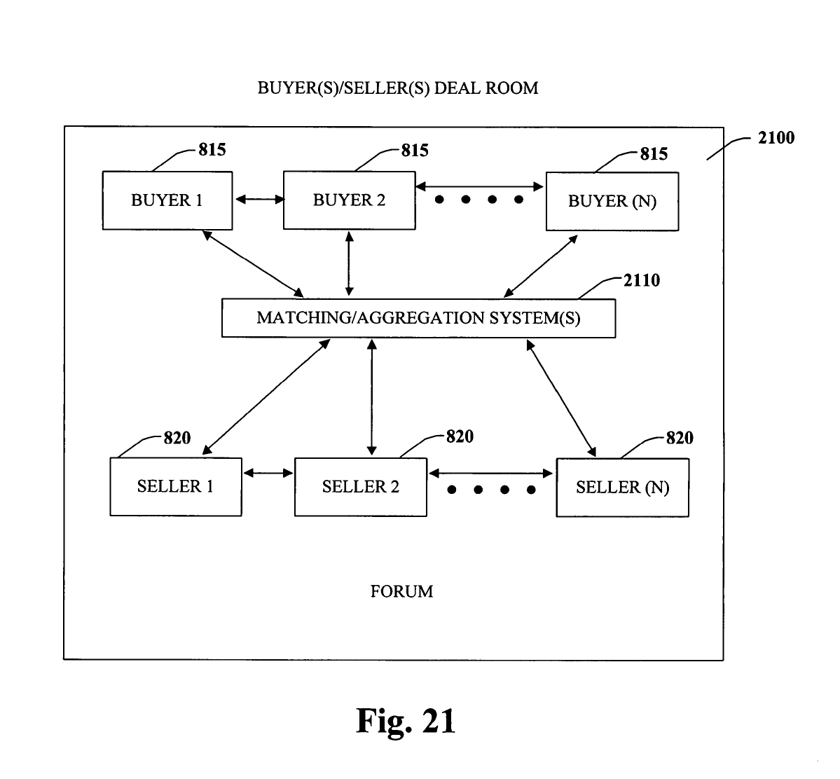

Turning now to FIG. 21, it is to be further appreciated that a buyer(s)/seller(s) deal room 2100 can be sponsored by multiple buyer(s) and seller(s). Similar to the aforementioned deal rooms, the sponsors are able to enter criteria for the commerce of goods. The offers can be input into the Matching/Aggregation System(s) 2110 to adjust criteria of future deals.

### II. OpenOffer Management System

One alternative aspect of the invention affords for creating, altering, and/or managing OpenOffer sheets on more than one private deal room at the same time. This aspect of the invention (e.g., implemented via software) enables the company completing an OpenOffer Sheet to select those private deal rooms it wishes to submit the OpenOffer sheet. For example, a first OpenOffer sheet with one price and volume schedule may be automatically submitted to deal room #1 and #2. A second OpenOffer sheet can be submitted for the same product with different price points and volume schedules to deal room #3. The system enables a supplier to track any number of deal rooms and label a customer accordingly. The supplier may create subsets of private deal rooms at any time through grouping the deal rooms and saving them with a different name (e.g., —mid-size companies, tier one, large company). This enables the supplier the real-time ability to segment all or some customers according to any number of criteria and current pricing and capacity information. Therefore, the system is a tool for creating any number of pricing configurations among different products and updating those prices and volumes in a moment's notice among the selected deal rooms.

A company is able to see a pricing summary by product type across all deal rooms. For example, the ability to select a product category and have the system return a list of the prices submitted for each along with the current price and the lowest price to be achieved. This allows for the company to track pricing strategy across all deal rooms. The information can be reviewed in any number of configurations: pie chart, bar chart, scatter chart, etc. and any subsets of deal rooms. Statistical numbers are also available including totals, averages, etc.

The system also provides a running list of all buyers that have access to all deal rooms supported by the company. This is done through a search file in that private deal room and saved to the master management system. Every deal room has a different URL such as WCeWinWin.com or ADeWinWin.com with the requisite security. The system is also capable of performing a search by entering the customer name which then provides the proper deal room and password. Changes may be made by the supplier. The option to have an OpenOffer Sheet posted on a regular interval and/or to have it programmed to reset the offer with a rolling date (e.g., daily, weekly, bi-weekly, monthly) is available on the master and individual sites. In addition, the ability to alter a component(s) of the OpenOffer Sheet and save that variation under a different stored name is possible. For example, if price is selected to stay constant while the ship date changes to the next business day on a regular interval, that open offer sheet can be saved and posted. The iteration will change with the passing of time. Likewise, the function of freezing all OpenOffer sheets with or without intervals is possible with a simple freeze command.

The ability to retract a previous OpenOffer sheet is available as well. This recall feature will pull the offers from all of the deal rooms or a combination selected by the supplier. The product name and identification number can be accessed and the recall feature engaged. In the event that orders are already placed within the open offer sheets, the supplier will fulfill the order as scheduled.

The supplier can also list and search open offers that have no orders. This is done with a quick search that will pull up the open offers, deal room URL, projected ship date, etc. The master list can be perused and when highlighted, the supplier has the option of modifying the information accordingly and then post again within the specified deal rooms. Such changes as price, volumes, ship dates, close dates, etc. can be made and the new deal rooms submitted. The ability for a supplier to create another deal room online instantly is available. The option is resident on particular website (e.g., the current site). The supplier highlights a “create new deal room” option and is presented with the room identification number and the base URL. The supplier is asked to name the URL with up to a certain number of digits. Once the name and administrator's password is selected, the new deal room is available. Additional information including contact name, e-mail address of contact, and the like is resident.

The ability for a company to create a private deal room online for invited buyers is provided. The invited buyers are notified of the opening of the deal room and given a username and password, so that their name remains anonymous. Preferred customers can also be given special pseudo names, so that they can travel from deal room to deal room, while maintaining their anonymity from reports generated by other suppliers and buyers utilizing the OpenOffer Management system. The option of automatically sending e-mail notification of the deal to preferred customers is provided.

The ability for a company to create a private deal room online, without revealing their identity is provided. The supplier can enter a pseudo name and basic company criteria, such as the type of company (e.g., Fortune 500, midsize, small . . . ), quality ranking, type of business (e.g., specialized, conglomerate). The company can then track purchases and demand utilizing the pseudo name. The deal room can be configured to be offered to a specified group, such as distributors or preferred customers, or the general public as a blind offer. The deal room can be configured as a single order deal or as a time specified deal that allows buyers to aggregate in and reduce the price. The ability to request transaction fees in real-time across all deal rooms. The fee structure is applied for that customer based on the number of single transactions (e.g., completion of open offer sheet by customer) and this figure is calculated accordingly for an online transactional fee.

### III. Demand Aggregator/Aggregation System

This aspect of the subject invention (e.g., implemented via software) captures and collates either all current or historical orders from all OpenOffer sheets. An OpenOffer Request Form enables a buyer on the system to alert suppliers of the product needed to category, quantity and shipment needs. This allows the suppliers to respond with OpenOffer Sheets that match this need. The alert is made by e-mail to a designated address given by the supplier. The buyer can request a private deal room, so that the identity of the buyer remains anonymous. Additionally, the buyer can provide a pseudo name or an e-mail address, so that the supplier can notify the buyer or post a message to the buyer.

An OpenOffer Request Summary is available by product category. For instance, the supplier may wish to aggregate requests from all deal rooms by product category. In this way, the supplier may see the level of demand of its buyers in advance of placing an OpenOffer for the product. This feature can be accessed in real-time. An icon can be clicked to show the summary of products being requested and pertinent data related to shipments. Excess capacity can be priced to preferred customers. The ability to compare current orders for a product on a timeline with the aggregated volume received from OpenOffer Requests for the same product and requested ship dates is also available. This aggregation and comparison enables the supplier to more accurately determine production estimates and forecasts. This allows for better planned production and the ability to evaluate the cost savings in terms of labor, material, production runs, etc. which, in turn, enables the supplier to estimate the savings and prepare the appropriate price and volume points. A search engine system is included for searching for deals over different supplier sites including the particular product requested. Other information included in the system can include but is not limited to:
Total capacity posted by product, total, timeline, etc.
Total number of orders placed by product, total, timeline, etc.
Percent of capacity remaining by each product category measured over the timeline
Average price per product by product category, by deal room, by customer, etc.
Historical timeline of product ordered, average price, breakdown by DealRoom, etc.
Historical review of total capacity listed by product that went unpurchased
Historical review of total orders over days, weeks, months, quarters, etc.
Chart of top customers for each product line
Projected sales taking historic information by product and extrapolating over time by weeks, months, etc.
Trend analysis of product mix over periods of time
Ability to evaluate the volume of unpurchased product over the upcoming months and when such capacity will be taken off market (e.g., —termination of specials from completed OpenOffer Sheets with close dates)

### IV. Private Buyer DealRoom Management System

This aspect of the invention affords the buyer to review product summaries and order information in any number of ways on the system based on private buyer deal room transactions:
Total orders placed by product, group, average, etc.
Total share by product type for each supplier—measured over days, weeks, months, etc.
Summary of supplier ranking by product category
Summary of current pricing information by product category
Historical review of total orders over days, weeks, months, quarters, etc.
Projected orders for each product taking historic information and extrapolating over time by weeks, months, etc.
Trend analysis of product mix over periods of time
This trend analysis is available on the site for suppliers to review in order to complete OpenOffer Sheets with relevant volumes
Ability to compare percentage of products delivered on-time by product category over days, weeks, months, etc, Ability to compare percentage of products that meet quality criteria
Ability to compare percentage of product suppliers with good customer service
Ability to trend the price for a product over time: days, months, quarters, years
Ability to profile a supplier over any period of time in price, quality, customer service, and deliver with a line chart showing trends to those suppliers via e-mail
Ability to profile suppliers of a similar product in such a way to compare performance over time
Ability to provide access for suppliers to see relative performance of their company versus other companies in the same category
The function of setting minimum performance rankings for suppliers and when suppliers fail to meet these standards, the buyer is notified of—the buyer has the option of having an icon to click which will list those suppliers who are in jeopardy along with a brief order summary and ranking totals
Ability to send to new suppliers via e-mail
Ability to review the number of orders placed online and the fees associated with the orders

### V. Trend Analysis System

This aspect of the invention (e.g., implemented via software) captures and collates either all current or historical orders from all OpenOffer and OpenOffer Request sheets. The trend analysis system aggregates the patterns of buyers with regard to purchases and demand. The trend analysis system also aggregates the patterns of suppliers with regard to offers and performance criteria to form a variety of trend analysis reports. The system also enables analysis to facilitate buying blocks for buyers and to assist suppliers in adjustment of their deal room offers. Additionally, the trend analysis system provides reports on anonymous buyers and sellers by their psuedo name. The system can communicate between websites to rank suppliers based on different criteria, and can also establish transactional profiles based on industries, geographical location and time periods. The various trend analyses can be provided in different formats (e.g., pie charts, time lines, etc.). The trend analysis system can be utilized to identify various problems with buyer OpenOfferRequest trends and supplier OpenOffer trends and communicated back to the buyers and/or suppliers.

### VI. Market Share System Reports

This aspect of the subject invention is capable of providing a file for suppliers to see the relative market share they have for a single product versus their competition. Substantially every item but price is able to be reviewed by the supplier online with the same functionality as the private buyer deal room management system.

### VII. Dynamic Pricing Model

The previous activity of the buyer on a site is recorded through such criteria as amount of cancelled orders (as expressed by a number of percent), the track record of on-time payment, etc., until a ranking is assigned to the buyer either manually or by default criteria set by the manufacturer. For instance, a buyer with a 100% rate of taking receipt of all orders online and 100% of paying within 30 days would be assigned a high value such as AA. When this buyer returned to the site and entered a password, the AA rating would be denoted and a series of value-added services would be made available to that buyer such as a 5% discount for placing an aggregated order, special offers such as a rebate of x amount when the buyer is the first to place an order in the aggregated OpenOffer, etc.

In addition, a dynamic price can be assigned to the ranking of a buyer. For instance, buyers can be ranked in various groups such as AA, BB, or CC based on their past history. The AA can be tied to an automatic 5% discount whereby all aggregated prices change automatically when the password of that company is entered. A company with a CC ranking could actually see a 5% premium when they visited the same site, simply based on their password and past performance. A buyer that has a history of canceling may carry a higher cost to the supplier. This cost, in turn, can be programmed into that particular buyer's ranking on the site. In this way, additional DealRooms may not be required as the same DealRoom will take on the characteristics of that buyer.

The rating of a buyer on one particular DealRoom can be aggregated and averaged along with the DealRooms of other suppliers to develop an accurate buyer profile. This profile can be accessed by supplier to determine customer access and prices.

### VIII. Not Exceed Pricing Option

A supplier can list as an option for certain customers a Not To Exceed (NTE) option. In this case, a buyer has already negotiated a NTE price through a blanket contract for a set period of time (e.g., one year). The NTE tag along with the set price is programmed into the site through a series of criteria fields. The buyer can place orders on the aggregated schedule at any time. If the eventual price is below the NTE price, the order is executed at the lower price. If the eventual price is above the NTE price, the buyer is guaranteed that the highest price paid will be the NTE price. As such, the buyer is capable of improving the pre-negotiated price. Thus, the buyer can use regional prices to their advantage, and the supplier can secure a fixed period contract to baseload the business while adding value for this prime customer.

### IX. Baseload Option

The baseload option status can be conferred upon a buyer by the supplier. In this case, the supplier negotiates a better price at the onset of the year in exchange for guaranteed acceptance by the buyer of product orders throughout the year. Once the buyer accepts shipment over the course of the year on pre-determined dates, the supplier can then post planned inventory in advance based on this baseloaded business. For instance, if the buyer agrees to accept shipment of 100 racks of glass the first week of every month for the next six months, the supplier then posts the availability of an additional 50 racks of the same glass for the same week. The existence of the original buyer provides a base to the supplier that absorbs much of the fixed costs associated with the scheduling while the incremental 50 racks represent proper capacity utilization at much higher profit margins. The schedule can be posted in advance at prices that create an incentive for additional orders from other buyers on the site. A NTE price option can also be given to this supplier.

### X. Show Status

This status can be conferred on a buyer as an incentive for the buyer to place orders early in the cycle of a product. One way to confer status is through a point system. Every time a buyer is the first to place an order in an OpenOffer Sheet, points can be accrued that result in a year-end rebate or some other incentive. For instance, 5 points assigned to every time the company is the first to order in an OpenOffer sheet applies towards the points needed by the end of the year to secure a discount. Such an incentive creates customer loyalty and rewards a buyer beyond the current system of discounts. Likewise, a rating system applied to non-cancellation or proper payment could further reinforce this behavior.

### XI. Real-time Price Update Screen

A screen setting is available that allows a buyer to post a series of product categories in a deal room with the current price setting and the close date. The buyer is able to check the current price of clear glass, for example, on a real-time basis by supplier or group of suppliers, and the respective volume still available by the close date. A product exchange is literally available to the buyer on an as-needed and customized basis. Likewise, the supplier can have a screen that shows the current prices of all OpenOffers across deal rooms and additional information.

### XII. Scheduled Production by Product Category

The supplier is capable of engaging a feature in the system to aggregate, by product category, the total amount of product that has been ordered, when it is due to ship and the remaining amount of product that is still available. By inputting the amount of available inventory of the product on site, the supplier is able to see the production schedule for the product over the next duration of a week, month, quarter or year. This schedule can be viewed in a graph form with total capacity acting as the backdrop to total production currently booked. The system is capable of incorporating information from the supplier's MRP (Manufacturing Resource Planning) system in order to determine the total capacity available. Also, a field of total capacity per time period can be inserted. Now, the system can return an OpenOffer sheet automatically with the amount of volume available. The supplier can split the product offering among a couple of different OpenOffer Sheets and DealRooms. The system can also alert the supplier of the DealRoom with the highest price, historically, and where the excess volume should be placed.

### XII. Demand Forecast System

The buyer and supplier both have access to a historical purchase by a product category. The buyer can review historic product demand schedules and request that the DFS take over. The Demand Forecast System takes the preceding history and conducts an average, extrapolating into the future the anticipated demand. This demand is automatically placed into OpenOffer sheets. The OpenOffer sheets can be sent to the suppliers for that product category. The supplier simply assigns a price schedule based on the volume and submits the form to the deal room. The process saves the supplier and buyer from calculating or requesting forecasted demand manually.

### XIII. Reactive Pricing Model Based on Orders for Product

In this case, the supplier has the option of lowering a price automatically based on market activity. A supplier of clear glass has set a price and volume schedule. If the activity of the site is such that multiple glass orders have been placed, and the data show such orders have taken place with other suppliers of the same product, registered discounts may be triggered by such activity automatically if pre-determined by the supplier. No pricing information is shared. Rather it is simply based on the volume of product. The supplier may come in with pricing starting at $0.29 per square foot of glass. If the trigger point is reached with enough orders being placed with other suppliers, the price is dropped to a pre-determined schedule already determined by the supplier. Conversely, the price can be set to increase if activity is skewed too heavily to the supplier in question. In this case, if orders are coming in sooner than anticipated the supplier has the option to pull the pricing schedule automatically (either dropping all current orders to their lowest point or not) and resubmit the pricing at a different schedule predetermined by the supplier.

Also, the supplier can program the price feature to engage over several deal rooms. For instance, assuming the glass price in one deal room is priced higher and is being accepted by the customer, the system will automatically alert the supplier of this happening and suggest additional volume be placed in that room. The program could also allow for the supplier to automatically post more product, say a specified amount, to the deal room with the highest price.

Additional criteria can be added to this analysis. Assuming a deal room profile of customers that accept the order on-time, pay in a timely manner, and pay a higher price than other deal rooms would automatically be listed as the first company to receive the next available product volume.

### XIV. Reactive Pricing Model Based on Time Left

A timed offer can also be preset with the supplier having the ability to preset dynamic pricing as the time elapses on a open offer sheet. Assuming no one has placed an order or if available quantities are still available, the price can be programmed to drop by a percentage throughout the remainder of the bid until a hidden price point is reached. The buyers are encouraged to place their orders accordingly until the market price has been established. Other aspects of purchasing can also be included, such as, times purchased, number of visits before order, price point at first visit, second visit, products ordered, etc.

The record can also include information from the supplier, such as whether a prospective buyer pays on time (yes or no, or ranking applied, rating, etc.), whether a prospective buyer pays on time (yes or no, or ranking applied, rating, etc.) and whether a prospective buyer gives a supplier only 40% of business (potential to get more business)? If yes, then the buyer joins another group segmented by the supplier). Special offers to buyers, such as discounts and/or coupons, which may be in the form of a percent off the curve or a new curve if a buyer agrees to place an order during this visit.

The cost to service customers can vary according to a variety of factors. One of which is when the order is placed. For example, the sooner an order is placed, the more beneficial it is to the supplier with the ability to plan production to reduce costs of the subsequent orders. The earlier an order is placed and the larger the amount, the more value may be created.

### XV. Incentive to Place Orders Sooner

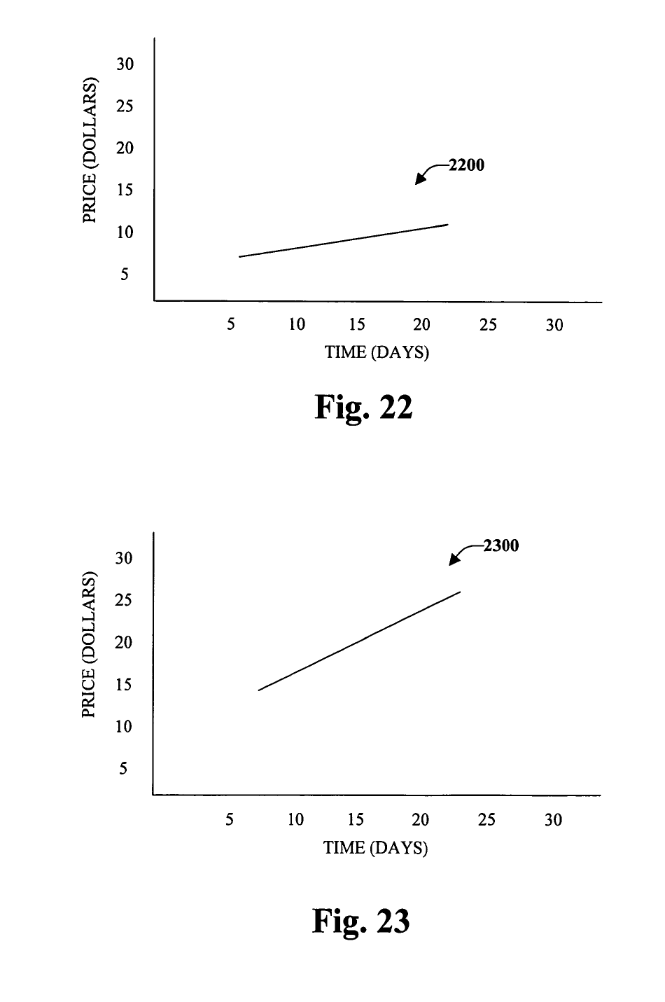

One example of motivating buyers to place orders sooner involves an initial offering of lower curves to a group of buyers. The curve (or curves) can change according to a pre-determined set of criteria. For instance, buyer A sees a curve 2200 as shown in FIG. 22. As orders are placed, the curve can be constant for that group of buyers, or a lower tier can change. This can be specified in advance to the buyers by the supplier.

However, as shown in FIG. 23, subsequent buyers may see a different curve 2300 for the same product with any number of variations (e.g., first price is different, price breaks vary, low price is different). This curve 2300 rewards the buyers willing to place an order earlier and lets the supplier plan the production run in advance.

A customer relations management (CRM) system can record all of this information for each buyer so that custom curves can be set-up by the supplier. For instance, assume a buyer has ordered product A three times over the past six months. The first order was placed when the product price was $22, the second when it was $20 and the third when it was $20 again. The final price received was $17, $16 and $15 respectively. The next curve the buyer may see will be set automatically based on the supplier's specification. Examples of such specifications include but are not limited to:
Past price average over x period of time (number of orders, period of time, etc.) will be the first, middle or last price seen as determined by the supplier
First price point will be x % above the last order price placed
Last price received (curve bottom is set x % below that price, initial price is set at x % above the curve top).
Past price first view
Past price first order

The CRM system of the subject invention can evaluate buyer patterns and tendencies and determine the optimal price curve for each buyer, group of buyers, sub-segment of buyers, etc. Such curves will be created in rapid succession whenever the tool is constructed and filled out by the supplier for each buyer. Curves will be created around a particular buyer's online experiences.

A seller may also designate an instant Not to exceed (NTE) price based on certain buyers going online. For instance, in the previous example buyer A may go online and be offered a price somewhere in the middle of the curve as a NTE $18 dollars. In which case, the buyer will be guaranteed that price at a maximum with the potential to get a better price as the volume increases. These alerts can be customized based on the data collected from that buyer and set into the software to appear on selected products and offers. These can also be sent to directly to the buyers via software generated HTML updates and notices of the offer, sent to voice mail, PDA's etc.

A buyer may also be given the special offer after closing to receive an additional 2% of the total price to help facilitate more sales. Other specials can include: order now and receive free shipping, a 5% off the next order or this order, free storage for x number of days, etc.

The CRM software can record every offer ever made to a buyer and document which offer(s) was successful. This information can be analyzed for buyer patterns and provide input on future curves/new buyer segments, etc. For instance, buyers that ordered at a price point of $20 were 80% more likely to add to the order when free shipping was included.

Likewise, data from online questionnaires can be tabulated and presented as part of the buyer profile and used in future offers. A buyer who states they like the free shipping feature can be segmented into a group in which that offer is made available; the new price curve may reflect a surcharge for such feature.

Conversely, buyers who like the no-cost storage for 30 days could see a different curve automatically with that a part of the offer. In this way, the buyer's behavior and input will be used to automatically present curves that reflect their wants and/or needs.

### XVI. Option to Sell Back to the Supplier:

Buyers may also buy futures of a product. For instance, a group offer may be presented. The buyer can place the order for X quantity. The supplier has the right to buy back the product from the buyer if desired. The buyer may be given a lower price for this option. Thus, the buyer can take the product for predetermined period of time, and the supplier may buy back the product at a same (or different) price if desired.

### XVII. Buyer can Select Price Curves:

A supplier can post three curves for the same product and a buyer can select which price curve will be applied to a particular product by accepting different terms and conditions associated with each curve.

### XVII. Offers May be Personalized

Buyers can receive personalized offers, such as, place order now, place order on your next visit, place order within x period of time, add to your initial order and receive X % more off this purchase or receive a deeper discount curve.

### XIX. One Click Add to Initial Order

A buyer can have the ability add to a previous order without going back to a website. For example, HTML (voice mail, pda, cell phone . . . ) can be generated and sent to the buyer showing the price curve and the total volume ordered. Based on this knowledge, the buyer is able to click on the HTML and be directly be sent to the curve's order form (or have fields already presented there) and add to the initial order. The system would update the order automatically, post the new volume on the purchase order and update the curve at the same time.

Likewise, special offers can be delivered via this same medium. For instance, a special offer for a buyer to order now and immediately receive 3% off the price of the product regardless of any more orders being placed would allow a buyer to add to the order.

### XX. One Click Extend the Offer

A supplier is able to click an icon which opens the curve's close date. An automatic message can be generated within a specified period of time (e.g., x days before close, a few hours before close, etc.) that asks the supplier if the offer should be extended for x hours, days, etc. The supplier can simply click on an icon and a field appears in which the supplier selects an acceptable time period. An email may then generate an automatic alert letting buyers know of this opportunity.

This feature can also be sent to those buyers listed in the CRM program that have or have not visited the offer. The curve can be sent to the group of buyers with the extension and price. A special offer can be included as well that offers these buyers an extra incentive to place an order. Since the buyers are registered, they can agree to place an order from the HTML notice if they have engaged this feature on their end.

Changes in minimum order quantities can also be done via a notification system. The supplier may specify a certain minimum for an offer. Once it is reached, a notice can go out which changes the minimum for future purchases. Also, once a minimum quantity is reached, the supplier can set the program to change the price curve. Future buyers may see different starting, middle and ending price figures.

### XXI. Spot Curves

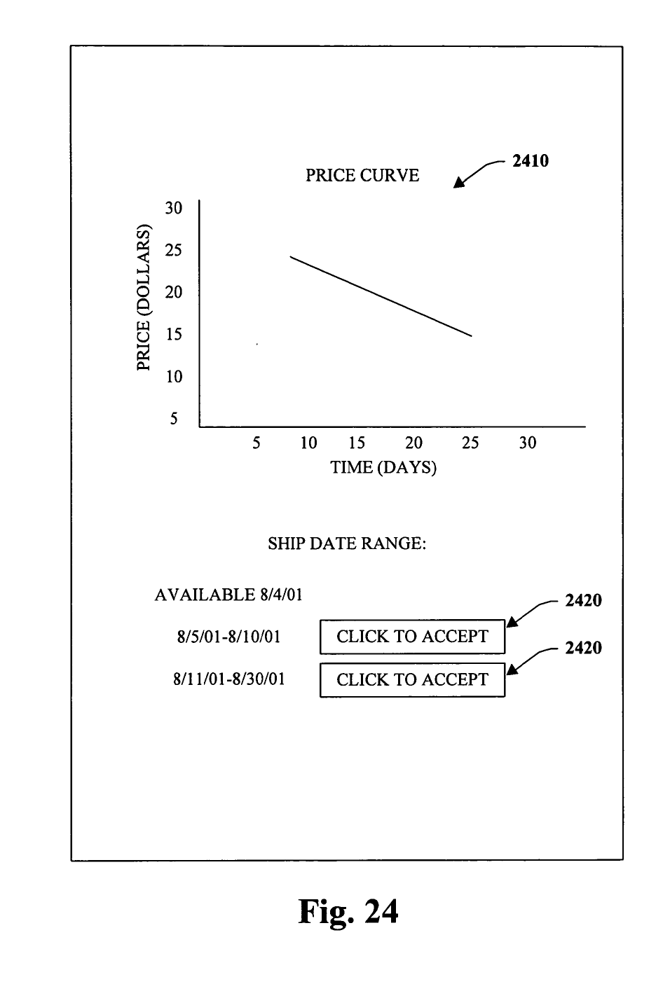

A supplier can create spot curve such as spot curve 2410, as shown in FIG. 24. This feature can be used when inventory is high and certain products must be moved. In this case, an offer can be extended for a period of time. A buyer may come in and place an order for the product and then take the product immediately or along the period assigned. The final price will be determined at the end of the order period which may come after the product is already at the buyer's location. Spot curves can be sent to buyers via the CRM package and offer buyers another incentive to place an order immediately. The interface facilitates immediate acceptance of the conditional offer through one click acceptance 2420. The one click acceptance offers an icon in which a buyer can click to select the offer with the desired conditions.

The buyer also has the ability to change the accept date. The system will calculate the new price based on the underlying carrying cost. An alert will go out to the buyer (he can request to be notified within a period of time).

For instance, a buyer has agreed to purchase 20 tons of steel. He specifies 10 tons to be delivered on the 10th and the other 10 tons to be delivered on the 30th. The total order is then calculated based on what surcharge has been placed on the offer by the supplier (the surcharge may also be $0). As more buyers order, the price drops according to the curve. A ship location may also be identified to specify if the first 10 tons need to be delivered to a certain location and the second 10 tons to a different location. A ship icon can be used to present the transportation costs and a total icon can be used to present the total costs to the buyer.

### XXII. Product Offers According to Date Criteria

A supplier can offer products according to a specific date range (e.g. —week) or by a particular date. A buyer could have the option of choosing an icon for a specific date to have delivery made. The supplier can add the costs per day or even per hour, on each ship date. The buyer gets the benefit of a group purchase with receipt at the given time. If the buyer needs to change the ship date, he can do so by clicking on change ship date. The quantities ordered, the shipping location, the order number, the date of delivery, etc. can be listed and a Modify button can be clicked to change the quantities shipped and the dates. If the change is outside of a predetermined range, a cost may be levied. If the date specified is in such a range that carries a surcharge, then the buyer would be billed the extra cost (a calculation can be set by the measured quantity such as tons and the carrying cost per day associated with that unit). This is an optional feature that can be turned on or off dependent upon the supplier and what groups of buyers have this feature engaged.

Also, this feature can be turned off during the offer and an HTML can be sent to buyers letting them know the order can be placed and they will not be charged for storage up until x date. This is a semi-automatic or automatic feature that is embedded in the software.

A shipping icon can flash once an order has been placed asking the buyer if they would like to arrange for shipping at this time. The current price per mile or other form of pricing can be presented.

### XXIII. One Click Change Order

A buyer can click on an icon that directs them to his/her order page in which the buyer can change the options of the product selected. For example, a buyer may place an initial order for 50,000 units without specifying any or all of the options and/or details associated with the product. Later, the buyer can return and specify one or more of the options, ship dates, etc. for the products. There may or may not be a charge for this feature.

### XXIV. Buyer's Ability to Change Quantity

This feature allows a buyer to change a total quantity ordered. The curve may not change for the group of buyers who already ordered. This event, however, could trigger changes in slope, prices, quantities available, etc. for the other curves. A surcharge may be levied or not based on the supplier's decision.

### XXV. Curve Sets Automatically

A first price for a product may be $25 and a final price for the product may be $15. The software allows a supplier to define such prices along with a volume and a price curve can automatically calculates any price breaks. The supplier can specify a number of breaks that should be calculated, such as 2 or 3. Specify a shallow initial curve, and the curve automatically is set up, or specify a deeper curve, and the curve is presented.

### XXVI. Every Order Reduces the Price Curve

The uniqueness of this curve is that with every minimum order (if set), the price drops according to the curve. For instance, the supplier sets the top and bottom prices along with the volume. As every order is placed, the curve automatically reflects the current price (e.g. —could be in dollars, cents). Regardless, every order reduces the final price.

The slope can also change to reflect a deeper curve at the beginning, and then shallow out at the end. A supplier specifies the type of curve (an icon with different slopes can be presented and the supplier simply has to click on the slope of choice and the prices will calculate automatically). The curve is superior in many ways because the buyers don't need a larger incremental volume to be reached before receiving a lower price.

This curve can also be introduced into a regular curve. The initial curve starts out with segments. Buyers can be notified via HTML that the offer has been modified so that every order will drop the price. A minimum can also be changed. Regardless, the value to the buyers is the ability to add to their initial order and know that every unit will reduce their price even more. Multiple curves can be linked and de-linked at will by the supplier.

### XXVII. One Click Price Break Change

New price breaks can be introduced by a supplier with a single click of the icon. The price breaks are presented and the supplier can make changes by clicking on the break in question, clicking on a percent and clicking on reduce or increase, and pressing submit. All buyers, specified buyers, and/or those buyers who haven't seen price curve yet, etc. can be notified of the new price curve.

A buyer can have access to all such changes made by a particular supplier. For instance, in a buyer's deal room the information on the supplier's changes to curves, segments, prices, different buyers, etc. can be evaluated.

### XXVIII. Buyer Information

The supplier can make available to the buyer the average price for a product over the last X number of offers, time, etc. The metrics can be listed in their entirety, or in some form as controlled by the supplier (or buyer in the BSDR (Buyer Sponsored Deal Room)). Probabilities would be calculated and shown to the buyers: for instance there is a 70% probability the next price tier of x dollars will be reached with the margin of error displayed.

### XXIX. Alert System for Supplier

If a percentage of probability is not holding true on an order and time is passing quickly, an alert system will let the supplier know of the options available (i.e., drop price curve, shill order, offer special curve to certain buyers (e.g. A profile buyers).

### XXX. Integration of CRM, ERP (Enterprise Resource Planning) (e.g., for Production Scheduling) and Demand Aggregation System (DAS)

The following section describes how production scheduling, the supplier's CRM package, DAS and DAS CRM can interact with one another to create a system that adds value for buyers and suppliers.

By way of example, a production run can be scheduled for six weeks from now for product B with options X and Y available. The total quantity to be produced is x, and x+300 is the optimal run. The scheduler can indicate this to the product manager/sales manage, or the like, with the notice: Do we post the remaining quantity in the DealRoom? Or, the software will be written to automatically post these offers to the DealRoom with the same ship date, fob point, etc. populating accordingly to the buyers listed in the DealRoom/CRM package. Once the curve is created and confirmed (automatically or semi-automatically by the other party), the curve is posted in the DealRoom and the emails alerting the appropriate buyers (as listed in the CRM) and internal people (e.g. sales, inside customer service, etc.) are sent. Multiple curves may be sent, linear offers may be prepared (e.g. show curve 1 for 24 hours, if not takers post curve 2, etc.) or any number of other features may be included as listed in this patent application and other applications. Further elaborating on this feature, the software can be configured with a series of if, then instructions:
Post to first buyer price curve A
Post to second set of buyers price curve B
Post to third set of buyers price curve C

The system allows for the supplier to change the sequence and the time between offers (first offer may be for A, if no orders or a certain thresholds not ordered then offer B and C concurrently with linked curves). If an order were to be received online in the deal room, it would automatically populate the production schedule with quantity ordered and other specifics and/or the order entry software. Likewise, if an order came in from the order entry system, the change would be reflected in the deal room (e.g. capacity changed, minimums changed, curves changed, etc.). A stimulus event would impact the other parts of the system, and show up as a way to price out the available capacity. Likewise, cancelled orders/changes to production runs would immediately change the offers and order entry data. If the total quantity has been ordered, a notice would be sent to production regarding additional capacity/quantity.

A change in the production schedule would also alert the marketing/sales manager of available capacity and the ability to add to the curve. The cost curve for the product is also available for viewing. The manager can determine what price curve should be set. Also, customer feedback as to when they would like to receive their next order can be tabulated and sent to the production manager. The production manager can put into the schedule and agree to the total volume optimal in the run. The marketing manager is notified, approving of the offer specifics and the buyers to be contacted, and the order entry software is also contacted with the information and is shown on the screen for internal order takers/sales representatives.

The data collected from the order entry system regarding the customers who ordered, their volumes, prices, etc. can be shared and inputted into the CRM package for data analysis. Buyer spending limits set in the order entry system can be set and carried across to the DAS deal room. A credit system/amount available can also be referenced in the software and indicated to the buyer and supplier. If the buyer attempts to exceed his limit, a notice is given that he is doing so and needs to speak with the supplier. The order has not impacted the curve at this time.

### XXXI. One Time Only Curves

A supplier or seller is able to post curves that can be pulled at any time. Buyers are aware of these special offers and thus, may not choose to plan their production on this availability. These are truly spot opportunities and must be seized immediately. A guide can be provided to the buyers on the types of curves that can be presented.

### XXXII. Multi-Dimensional Curve

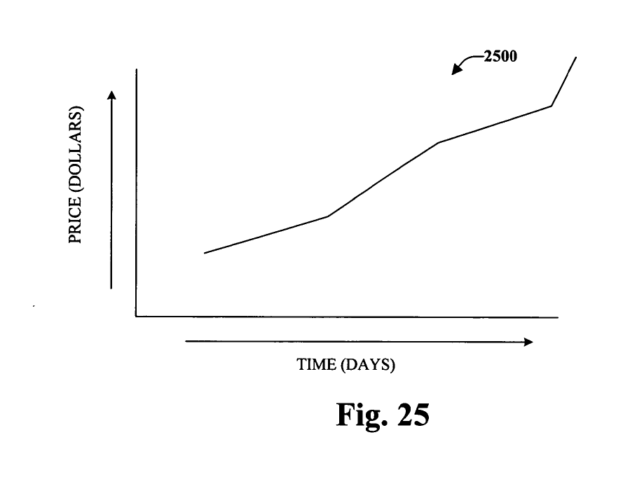

An example of a multi-dimensional curve 2500 is shown in FIG. 25. In this example, the buyer is encouraged to place an order sooner. Here, the buyer can see the earlier the order, the better the curve and final price. This would work for seasonal products where a supplier could truly benefit from early orders. Again, these curves can be dynamic, adjusting as set by the supplier and by the demand ordered. If the product is scarce or pricing is unknown, the supplier may offer these type of curve, or variations of it, to entice buyers to provide a pricing floor. Once done, then the other curves can be modified (higher or lower) and the earlier curve disappears for the rest of the buyers except for those that had already placed their orders.

A not to exceed option can also be placed in this model. The NTE means a buyer would never pay more than the existing price where they placed an order, even if the curve was going up. Further, a downward curve connected at the time of purchase may be offered to give the buyer a better opportunity to get a lower price.

### XXXIII. Option to Buy

A buyer can purchase an option to buy the product during the offer. For instance, a fee would be paid by the buyer to hold a slot in the production schedule for X number of product A. The supplier may post certain restrictions such as time of option to be exercised, etc. If the option is exercised, then the price is confirmed. If the option is not exercised, the supplier has this capacity to sell but would collect a fee from the buyer holding the option.

### XXXIV. Seasonal Price Curve

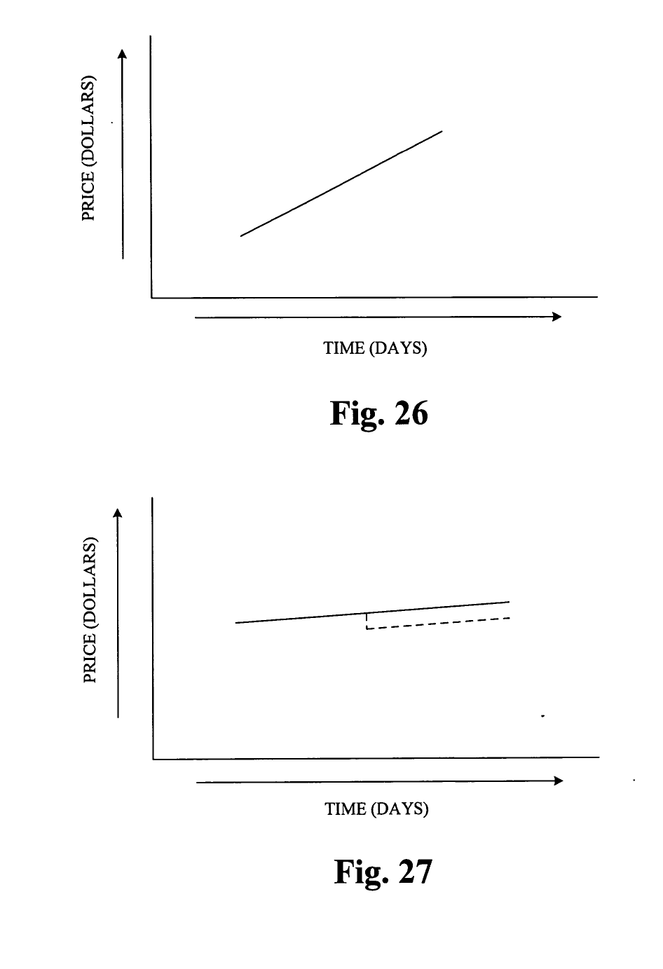

Another example of a curve 2600 is shown in FIG. 26 and is one that is set in advance and is time-sensitive. Offshoots tied to volume may or may not be included at during the offer.

XXXV. Option to have Production Schedule Underwritten by a Third Party

To set up a line and produce a product is a costly venture, especially if volume is not known or the run length is incomplete. Using DAS (Demand Aggregation System), a supplier will have the option for a third party to underwrite the cost of the production run if certain volumes are not ordered. Based on archival data, a third party can set the proper risk assessment and tie a financial figure to it. The software would record the figure and the volume required.

For example, a run would be set-up and a final volume reached. If the volume did not reach a certain threshold, then the third party would pay the supplier. If the volume did reach the threshold, then the third party would keep the payment. Partial volumes could also dictate what level of the payment would be released by the third party. In this way, a form of insurance could be purchased by the manufacturer producing the good. These contracts would be available for common trading among third parties.

Other factors which may be used in this example are: post production run, ship date, FOB point, product, quantity, history, the right to purchase X of product A within a specified period . . . option price of X. Buyers can also participate, being able to buy options to purchase X amount of product.

Another variation on the price curve is shown with respect to FIG. 27. Here, if an order is placed at a certain point, every other order placed by buyer will drop the price by x % (percentage in price drop represented by a dashed line).

### XXXVI. Notes on Software

Sales representatives/ISR's when viewing both pricing curves, forgers and service centers, for example, would like to know which curve they are viewing. Accordingly, a name and/or color can be provided thereon to denote them.

Currently sales reps are able to see the two different curves (e.g., Forgers and Service Centers). One way to remedy this is to give them options. When they log on, a drop down box on the first page (home page) would let them choose whether to see Steel Centers, Forgers, or any contract price people. In essence, they would be logged in as this person and be able to see exactly what the buyer was seeing. Also, the option of view all could be added. This option would allow them to see all the different curves. To distinguish, rather than color, an extra field could be added in the aggregated offers page. This field would provide the company name, or name of the group of buyers that were able to see this specific curve.

### XXXVII. Auto-Post and Re-Post Feature

For example, a supplier has posted an aggregated offer for ship date Y. An order enters the system from a buyer with a different ship date X specified (could be the internal ERP system, other order entry system). The order is taken and the system determines there is a new ship date with an X ship date. The system references the new ship date with the old. The system can be programmed to defer to the new ship date by a number of criteria (such as by the customer who ordered the product, the amount ordered, etc.). If so, the program can be set to automatically do the following:
If there are no orders for ship date Y, the system changes the ship date to X and can notify the buyers accordingly.
If there are orders for ship date Y, the system alerts those buyers via phone, fax, pda, email, etc. of the change in ship date.
If the buyer confirms the new ship date is acceptable, the order is added to offer X. An incentive (3% off your final price if you accept, etc.) may be offered by the system (as programmed by the supplier).
Another option would be the buyer refuses to accept the discount for the ship date. The buyer can then cancel the order via the system, or the supplier can honor the ship date of X as well as Y. The supplier can also automatically post the new ship date (X) in the Deal Room.

### XXXVIII. Change in Minimum Order Quantity

Product offers can be set up with a minimum order quantity to simulate normal business practices. The demand aggregation system or component of the subject invention also allows an offer to be configured with a multiple minimum order quantities. Once the volume on a particular offer reaches a predetermined level, the minimum order quantity can be lowered (or presumably, raised).

For example, an offer for 12L14 bar could be set up with an initial minimum order quantity of 10 tons. Once orders have been placed totaling 100 tons, the minimum order quantity could be lowered to 5 tons automatically.

### XXXIX. Customer-Determined Offer Availability

Product offers are generally determined by the supplier. However, DAS has the capability to survey buyers of a product. The buyer can indicate a desired purchasing schedule, indicating the types of products, product options, quantities and delivery dates. Using this information, a supplier can determine a production schedule that meets their internal goals, while accommodating customer demand.

### XL. New Offer Notification

As new offers are created, the demand aggregation system of the subject invention can aid with the marketing and promotion of those offers. During the offer creation process, DAS can notify the action manager of two potential pools of customers. First, DAS generates a list of customers who have purchased that particular product before. Second, DAS can generate a list of potential customers, based on the survey data of registered buyers.

Using these two lists of buyers, the action manager (or Supplier) can then create a targeted marketing program. DAS will allow new offer notification both by email and by fax, amongst other means. A buyer with a particular product tagged will automatically or semi-automatically receive alerts whenever the product has been ordered.

### XLI. New Pricing Notification

As orders on offers are placed, prices may fall based on the pre-determined price curve. As prices fall, DAS can generate different lists of customers, such as: those who have already placed orders; those who have purchased that particular product before; and potential customers, based on the survey data of registered buyers. An action manager can be notified of the price reduction and presented with the list. They can then elect to notify any or all of the groups to the new price (and savings) via email or fax or other means.

### XLII. Instant Order Form

A buyer can receive a real-time alert (e.g., HTIVIL, instant message, page, text message) notifying the buyer of the current price. An icon may then appear that allows the buyer to click on to place an order immediately. The system allows an approved buyer to bypass the front page (name and password sections) and the other pages in between, and be at the order page. The buyer simply enters the order (or adds to the already placed order) within a single key-stroke.

### XLIII. Tethered Price Curve

Every buyer is given a percent off the price of a product along with a scheduled discount curve based on total volume ordered The buyer's discount follows the buyer throughout the deal room and by product. As more volume is ordered for a particular product, (e.g., 100 tons), the buyer would experience the discount from their own price volume curve. In this way, 100 buyers could have 100 price curves while still aggregating their demand on the same curve. All buyers can be tethered off a production volume tied to a certain ship date or period.

### XLIV. Changing-Tethered Price Curve

The percent off could also change according to time or any other criteria selected by the supplier (e.g., product, FOB point, volume, etc.) If the buyer has not ordered yet, his personal discount may be reduced as more orders come in. Conversely, if few orders are placed, the buyer may see an increase in the discount curve until he orders. Once he does, his particular price curve is “locked in” for the remaining offer time.

### XLV. Sales Manager Dashboard

A sales manager dashboard can be incorporated into the subject system. The dashboard is designed to enable a user to quickly set up deal rooms, offers, products, customers, and customer groups. Each of these functions can be accessed from a standard web browser or wireless PDA, for instance. Thus, this mechanism allows quick set up and configuration of each set of data. The dashboard may also contain a plurality of wizards that can quickly configure a set of information. A deal room wizard allows a user to quickly create new groups of customers based on geography, company size, sales volume, or any other category grouping. A point and drag feature can be included to direct a potential buyer, a product offer, etc. to a deal room. An offer wizard allows a user to quickly create new offers, based on previous offers or entirely new offers. A product wizard allows a user to add products to be offered. A customer wizard allows a user to register new users by manually entering information or importing information from existing data sources (e.g., a spreadsheet). Users can be set up from a workstation or the information can be entered remotely from a wireless PDA. A customer group wizard allows a user to create new customer groups, reassign customers within groups, remove customers from groups, or remove entire groups.

Each wizard, upon substantially completing its function, has the ability to determine if another wizard should be invoked. For example, once the deal room wizard has completed setting up a new deal room and the customers that will have access to that deal room, the next logical step is to call the product wizard to create products that will be offered in the new deal room. The offer wizard could then be called next to configure the offers for those products. Likewise, the customer wizard can call the customer group wizard in order to assign a new customer to an appropriate group or groups of buyers.

The sales manager dashboard may be accessed via a phone line. For example: a user calls a 1800 number to access his DealRoom. The user is then asked to enter a code, which may be entered on the number pad or spoken into the phone receiver. Once accepted by the system, the user hears a series of prompts. The prompts may include:

To post a new offer, press or say 1. Here a series of prompts then walks the user through a series of fields to be completed (e.g., the product, starting price, price breaks, ending price, quantities). The user can at anytime review the information for accuracy. The company name and buyer(s) or groups of buyers that have access to the product are then entered. Finally, a confirmation is sent to the user to confirm the order. The confirmation may be sent via email, instant message, etc. After the initial offer, the software can automatically enter new offers for the user over the phone based on the user's input.

To add a new customer, press or say 2. Here a buyer can be added online with a notification (e.g., via email, instant message . . . ) sent to the buyer with user name and password information.

To change a customer's options, press or say 3. Here a customer can be added or removed from a specified deal room.

To find current orders, press or say 4. Here a user can find his current, outstanding orders, or a seller can find any outstanding orders by customer and/or product.

To find DealRoom information, press or say 5. Here a user can determine when a deal room will close, what the current product price in the deal room is, etc.

A user can navigate through and even customize the options in order to have access to any and all information available in a DealRoom. Restrictions upon these options may be set by a system administrator.

An example of the use of a sales manager's dashboard can be a quick configuration of offers for products after a sales meeting. When a supplier determines sales goals, focus on sales in a particular product line, or any other sales based initiatives, the system can be immediately configured to support these initiatives. For instance, new offers can be created for products determined to be hot sellers; new customer groups can be created to support initiatives to enter a new sales territory; and/or new DealRooms can be set up to accommodate a restructuring of sales accounts.

### XLVI. Action Manager Dashboard

The action manager can have access to part of or the entire operation of all deal rooms from multiple suppliers, multiple buyer and supplier price curves, etc. from a single screen. For example, drop down menus allow an action manager to see a list of all deal rooms by supplier. Selecting a folder allows the action manager to then see the various deal rooms within each supplier deal room. Selecting the folder again allows the action manager to view the products offered in that particular deal room. In one section of the screen, the action manager can search via filters/free text searches to pull up the name of a deal room, buyer, etc. Headings displayed in the search box can include new customers, existing customers, etc. A point and drag system lets the action manager put a new buyer into a proper deal room (listed in folders on a side of the screen). This tool enables the action manager to quickly post new customers to deal rooms, change access rights, or delete from the deal room. If the action manager selects a buyer name, another portion of the screen displays the individual buyer information as well as access to notes, contact information, name and password information, etc.

Another portion of the screen can include a delimiting function that allows the action manager to limit searches by state, company name, deal room folder, product folder, etc. Likewise, individual buyer information is available by selecting that particular folder. A product profile is also listed for each buyer which can be completed by a buyer via email, upon registration, or by the action manager during a phone call. Products are tagged and as orders are placed for those products, the buyer is alerted via email automatically sent from this dashboard. The orders can also be tabulated and viewed through the dashboard. The products the buyer purchases can be color coded to show a profile including but not limited to:
Orders a product frequently—chart the orders over time
Has ordered in the past—shows when that product was last purchased, click again to see all of their purchases for this product, at what price they entered their order, at what price they received when all the volume was added
Average price of when first order is placed
Percent savings from that price to the final price
Percent savings from the first list price versus the price where order was placed
Is order volume increasing over time, decreasing over time? Show graph
Superimpose trend of average price and total volume ordered . . . calculate the price sensitivity of this buyer: High, Medium, Low
Show range of the buys: min, max., average, median price points in a single graph
What is the price elasticity for this customer: As price drops, how much more is ordered
Average savings on product
Extrapolate how much customer will order over the year (based on data collected)
Show this on a graph compare to the average of all buyers for this product (tally from online orders for this item)
Develop a buyer profile showing the supplier (and possibly buyer) how often the buyer orders, etc. for quick reference whenever the buyer profile
Show curves for all of these features by different deal room segments
List feature—high price elasticity to low price elasticity . . .
Customer adds to order: very frequently, infrequently.
Supplier can group into segments: Green are tier 1 buyers, Blue tier two buyers . . . and decide to regroup the buyers into new deal rooms.

### XLVII. Alert System

As each of the wizards is called, a user can configure a series of notifications. These notifications can be done via email, fax, or paging, to a workstation, wireless PDA, or phone/pager. As part of the customer wizard, the user can choose to be notified the first time a new user logs onto the system, or the first time a user places an order. As part of the offer wizard, the user can choose to be notified when the first order is placed, when the volume of product ordered reaches a predetermined point, or when the offer is about to close.

### XLVIII. Posted Order not Shown

When an order is cancelled, the volume may not be removed from the price curve due to the desire to show price transparency. However, this is likely to cause the supplier a significant loss since the buying group will be given the discounted price without the ordering the volume of product that warrants such a discount. Cancellation fees may be imposed, however, if the cancellation takes place at the top of the curve, the margin of loss is still high. In order to protect a supplier from future losses, it is desired to keep the canceling buyer segregated from the other buyers. This can be done by showing the canceling buyer the curve that the other buyers see. If the canceling buyer places and order on his/her curve, this volume will be placed in his/her curve only. Thus, the other buyers will not be affected. When the offer closes, and if the canceling buyer has not cancelled the order, the volume will be added into the curve for the other buyers and the price will be discounted accordingly. This system could be accomplished by allowing a buyer to select an option to hold volume until close.

### XLIX. Purchasing Profile

The system can allow a customer to have a predefined purchasing profile. For example, if a customer typically purchases a particular product with particular options, the customer's personalized information will be automatically retrieved and entered when a new order for the customer is initiated. Likewise, if a customer has a contract pricing relationship with a supplier, the customer's contract price, along with the customer's standard options and purchase information will be automatically retrieved and entered when a new order for the customer is initiated.

Reminders, via email or instant message or the like, could also be sent to the customer based on his/her personal purchasing profile. For example, if a customer desires to place orders 45 days in advance for particular products, the system could send reminders to the purchasing agent if the customer has not ordered within the 45 days. It is to be appreciated that any predetermined amount of time may be configured for the reminders.

The system can also automatically update fields, such as the additional information field and the shipping instructions field, based on the customer's location. For example, if a customer typically has product A sent to his/her plant at location X and product B sent to his/her plant at location Y, the instructions specific to each product can be identified and attached to the appropriate orders.

Another variation is a buyer with multiple products that are ordered from a particular supplier. A listing of these products is placed in the buyer's customer profile. When a new curve is introduced for one of these products, the buyer receives an alert or feeder, as will be discussed in greater detail below. If the alert is received via email, the email can contain a link and/or order icon, which will allow the buyer to place a new order automatically. The customer profile can be further tailored to match ship dates between the profile and the supplier's product offering prior to sending an alert to the buyer.

The buyer may choose to have a feeder running across a portion of the buyer's home page, which displays the current offers and prices for products in the customer profile. The price and ship dates can be listed along with the price curves. An icon may be selected to see the current price curve. Thus, the buyer can view, firsthand, the ability to group a purchase. With one click, the buyer can access a particular deal room which displays the product curve and order page that the buyer is interested in. Or, from the feeder, the buyer can click on a product and an order screen for the product appears. The feeder can be updated in real-time to reflect new product prices and volumes available.

If the buyer has already placed an order for the product with a different ship date, the system displays the old ship date and the new ship date to the buyer. The buyer is then given the opportunity to transfer the order to the new ship date by selecting an accept new ship date icon. A confirmation notice via email, for example, is sent to the buyer to inform him/her of the specific terms (e.g., cancellation terms) of the offer. The information immediately allows the order to be put onto a group purchase option and the price curve reflects the new change.

### XLX. Posting Additional Price Breaks

The system can automatically, or semi-automatically, post additional price breaks within an existing offer. For instance, if an offer has a first price break of five dollars at 100 units and a second price break of ten dollars at 300 units, the system can automatically post price breaks according to a predefined schedule or prompt the supplier to post price breaks at various points between the 100 and 300 quantities. The ten dollars could be broken up equally (i.e., one dollar price break for every 40 units), or a variety of other pricing structures could be established, such as, more breaks at the beginning of the curve, more breaks at the end of the curve, and variations on the increments whether equally distributed or lower dollar amounts initially then higher, etc. The option, once selected by the supplier, could alter the price curves accordingly. Likewise, this feature could be integrated into the system with the ability to alert buyers via email, fax, phone, instant message, etc. of the new price breaks that have been established.

### L. Price Curve Creation Tool

A price curve creation tool allows a supplier to import existing customers and prices (e.g., contract and/or current price) and previous volumes ordered into a price curve. The price in the deal room curve can be established by having the supplier select a starting price curve and an option to put the same price on a first tier for a buyer with a predetermined percentage discount (e.g., 1% off current price when order is placed online), or an option to match an offline price to the first tier of an online curve. The rest of the curve can be created by using a wizard. The wizard can walk the supplier through each buyer's curve from a single screen view and then display a curve that reflects the price and volume breaks for that particular buyer. If the supplier changes quantities, the curve's slope will immediately change to reflect the new price breaks. These price curves can likewise be changed quickly by using the feature to modify an existing curve between deal rooms.

### LI. Displays for Aggregated Purchasing

Displays, where a supplier can post for buyers the changes in prices relative to ship dates and time of order, can include:
Show offers by the day over a period of time (e.g., calendar with 30 days).
Calendar for the product, which can coincide with the ship date.
A customer gains access to a deal room and sees a listing.
Current quantity available in stock and price of the current stock.
The current price can read the customer's contract price or default price set by the deal room where the buyer has been given access.
A calendar shows the dates for any period of time (e.g., day by day, week, month, quarter).
A price per unit measure (e.g., pound, carton).

For instance, a buyer could register to the deal room and instead of seeing a price curve upfront, the buyer would select a product category and then see a calendar appear with different prices for each date (e.g., tied to a ship date or receive date). As an example, on the first day of the month, a product has a price of $129/thousand and on the fifth day, the product has a price of $127/thousand. The buyer can select a day with a price by clicking on an icon. A price curve appears that shows where the price is in the curve, the next price break, quantity available, time for an order to be placed, etc. Other options also exist, which include but are not limited to:
a table with prices and quantities
a 3-dimensional chart that lays out the month along with the relative price points and quantities available, a curve that shows prices (e.g., lowest to highest) for the product, and price and time remaining for each offer
An L for the lowest price in view, 2L for the next lowest price, etc. can also be listed on the calendar for a quick view.

The buyer can place an order and add to the group's acceptance date. As the offer closes, the price is confirmed and the order executed.

A quick search can be done to find the lowest current price, the lowest potential price, etc. Or, a quick search can be done at the first page by selecting a product and having the chart appear accordingly, or the prices and dates offered appear.

Some dates on the calendar may not have any numbers which would reflect that the product is not available at that time (unless pulled from inventory in which a price can be put in that correlates to the contract price/pull from inventory price).

A carrying cost calendar can be used on the screen as well for the buyer to plug in numbers such a quantity needed, time before product is completely used, date initially needed; average consumption per day, total carrying cost percentages, etc. and the system will return the appropriate volume to order and date.

The system can display information such as: how many buyers have access to a particular offer, how many buyers have visited an offer to date, how much has been ordered by a group over the history of the product.

The system can also include a price protect feature for a supplier. For example, once a buyer has ordered, the screen, or calendar, is copied and is accessible for future use. The data can be forwarded to a database that will track the price and delivery variances and arrive at a price sensitivity profiles for the buyer and the particular product. The supplier can also use this information to generate future calendars for this buyer or other buyers. A ranking system will also be available to show the price sensitivity of this buyer as the different dates and prices are pulled into a database and a color-coded or ranking system is leveled that compares the buyers and puts them into categories, such as: high price sensitivity (1:3)—for every 1% decrease in price, the customer purchases 3% more; medium price sensitivity (1:1.125)—for every 1% decrease in price, the customer purchases 1.25% more, low price sensitivity, and no price sensitivity.

The calendar can also change in real-time based on the information fed into the system by a semi-automatic function (the user inputs changing volumes and prices) or a direct feeding of information from the supplier's ERP system. Current inventory levels would not only change, but also the available volumes.

The supplier or buyer can also have a save feature incorporated that allows the buyer to save the prices presented in the calendar for a period of time determined by the supplier. In this way, the buyer has access to a product's old prices for a period of time while still having access to the lower prices that may appear from changes to the calendar in the interim. It is a way to reward a buyer for participating in the program and can be done automatically by the software and given a name (e.g., calendar May 1, 2002) for quick access).

### LII. Offer Saves

The invention also contemplates employment of offer saves. Offer saves allow a buyer to save or freeze an offer online, for example, by saving a chart online. In some cases, freezing an offer can be a requirement from a supplier for a buyer to participate in deal room or with respect a given price curve.

### LIII. Demand Aggregation Across Deal Rooms

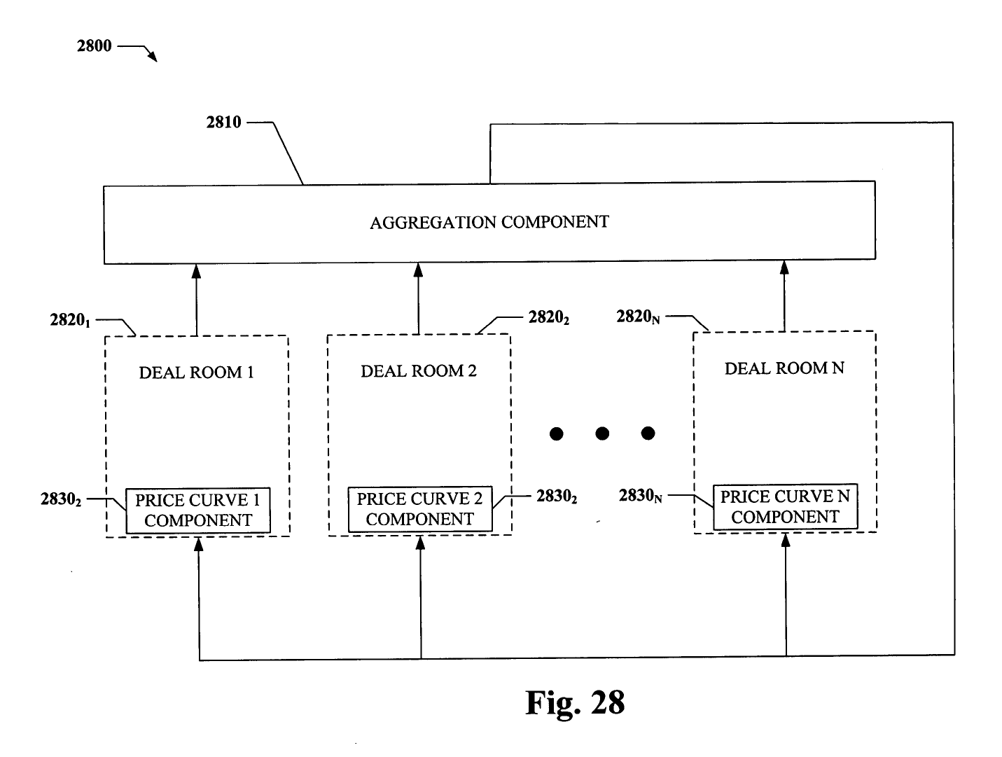

Turning to FIG. 28, a demand aggregation feedback control system 2800 is depicted. System 2800 is comprised of an aggregation component 2810 that interfaces to a plurality of deal rooms 28201-2820N, referred to collectively as deal rooms 2820. It is to be appreciated that although the deal rooms 2820 are being referred to collectively hereafter, respective deal rooms 2820 can have unique attributes that distinguish each of the deal rooms 2820. The deal rooms 2820 can contain price curve components 28301-2830N, hereinafter referred to as 2830. Similarly, each price curve component 2830 can have different properties associated with it. Such properties can relate to the type of data shown, the format of the data, the rate data is updated and so on.

Each of the deal rooms 2820 can be employed to facilitate communication between a buyer and a seller. Such communication can occur utilizing a plurality of technologies such as video conferencing, the Internet, teleconferencing and the like. The deal rooms 2820 can also be private, in that the deals shown to the buyer can have terms specific to the buyer. Such deals can be known only to the buyer and the seller that presents the deal. Entrance to one of the deal rooms 2820 can be accomplished a number of different ways such as by invitation, right of entry, etc. and such participation by the buyer in a specific deal room can be regulated by the seller.

As shown, the system 2800 is a feedback control system operative to utilize offers from each deal room to affect the price curves related to each buyer. Thus, a the deal rooms 2820 can generate a plurality of offers and such offers can be received by the aggregation component 2810, which in turn determines appropriate price curves for each buyer. After such price curves have been determined, data is sent to the price curve component 2830 to present to the buyer located within a specific deal room.

Communication between the components can be facilitated via various technologies such as wireless, coaxial cable, Ethernet, etc. Thus, the deal rooms 2820, the price curve components 2830 and the aggregation component 2810 can be local or remote to each other as desired. For example, a buyer can be located in his office and employ the Internet to view a supplier price curve relating to a good for sale. In addition, the aggregation component 2810 can learn behavior via inference. As utilized herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can refer to techniques employed for composing higher-level events from a set of events and/or data. Such inference can result in the construction of new events or actions from a set of observed events and/or stored event data, whether or not the events are correlated in close temporal proximity, and whether the events and data come from one or several event and data sources. Various classification schemes and/or systems (e.g., support vector machines, neural networks (e.g., back-propagation, feed forward back propagation, radial bases and fuzzy logic), expert systems, Bayesian networks, and data fusion) can be employed in connection with performing automatic and/or inferred action in connection with the subject invention.

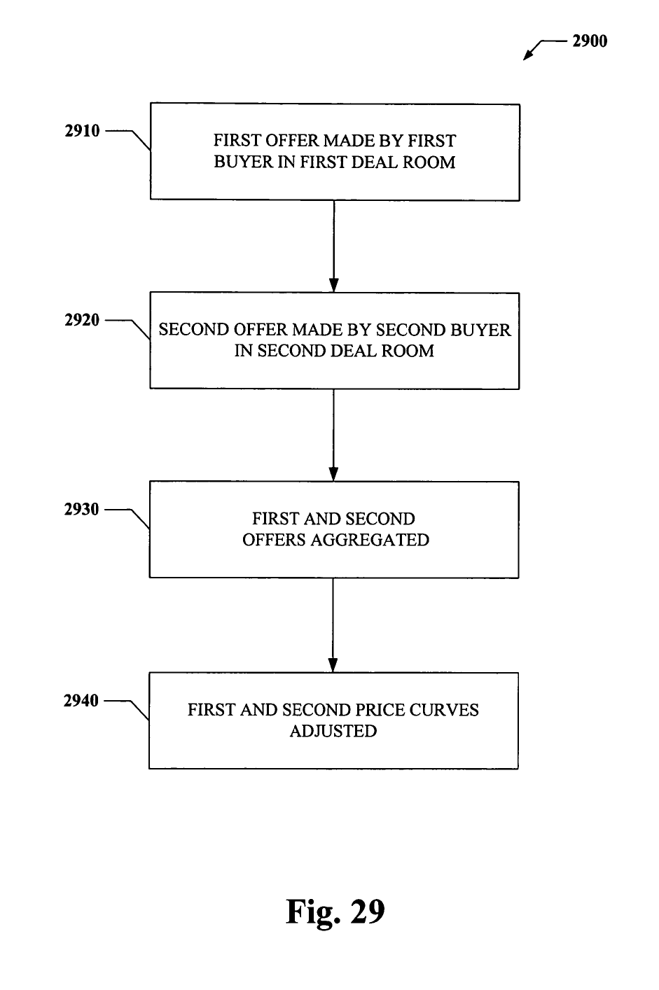

Referring now to FIG. 29, which shows a methodology 2900 wherein price curves are adjusted based on the aggregation of offers. As previously described, demand aggregation can be employed by a sponsor (e.g., supplier, seller . . . ) of a private location (e.g., deal room) which can result in myriad implications for buyers which are invited to participate by the sponsor. For example, a supplier can have 50,000 widgets for sale and send a private offer for these goods to five buyers and the buyers have a period in which to accept. The offer can be dynamic such that the offer for any given buyer can change depending upon the activities and responses of the other four buyers.

In addition, the potential buyers and/or groups of buyers can be prioritized which can allow certain buyers/groups to be offered the deal ahead of others. In essence, such a structure would create a “right of first refusal” for select buyers that have a higher level of priority with a given sponsor. In a single deal room, a plurality of offers can be made available to a buyer. For instance, 100 buyers can see 100 different offers based on their own particular situations, yet, the activity of each buyer can be connected to and affects the other buyers. Additionally, activity in one private environment can have a direct or indirect impact on another private environment. For example, offers, terms and conditions, prices, options, ship dates, etc. can change or stay constant as a result of the sponsor's underlying offer mechanics.

Moreover, various views can be employed to offers. For example, one view could be a price curve, another could be a calendar showing price variations based on the number of offers accepted. Offers could be displayed in any number of different formats including charts, graphs and other visuals to display the offers in an easy to understand format.

A buyer can receive and/or retrieve offers in any number of formats employed by various platforms such as a PDA, email, internet hyperlink, phone, etc. Such offer data can be saved and categorized to allow a buyer to access such information at a later time. Additionally, alarms can scheduled so that the buyer is notified when a new offer is available, when an offer is about to expire, etc.

According to an aspect of the invention, price curves can be displayed to buyers or potential buyers in private deal rooms (or alternatively a public deal room). That is, a buyer or a plurality of buyers in one deal room are able make a purchase according to one price curve, while a buyer or group of buyers in yet another private deal room view and are able to make purchases according to a different price curve. Accordingly, price curves directed at particular buyers or potential buyers are distinct and separate from those directed at others. However, price curves can be dependent on other price curves. Activity in one private environment can have a direct or indirect impact on another private environment—offers, terms, conditions, prices, options, ship dates, can change or stay constant as a result of a sponsor's underlying offer mechanics.

At 2910, a first offer is made by a first buyer in a first deal room. Such an offer can be made remotely or locally and can employ any number of technologies to facilitate communication between the buyer and the seller. It is to be appreciated that the offer made by the first buyer can be based on the specific price curve given to or associated with the buyer. At 2920, a second offer is made by a second buyer in a second deal room. Such an offer can be made before, after or simultaneous to the first offer made at 2910. The second offer can be independent of the first offer and a common seller can be the only party aware of both offers. Thus, the private deal room structure can allow a seller to make changes to the price curves as they relate to each other.

At 2930, the offers made by the two buyers are aggregated. Data related to each offer such as ship date, delivery date, cost etc. can be compared using any type of relationship to determine a desired output (e.g., average cost, median lead time, total volume, etc.) After such data is gathered and manipulated, the seller can make adjustments to the amount a buyer will pay for specified goods. At 2940, the price curves for the first and second buyers can be adjusted for example with respect to an aggregate demand that includes the offers made in the first and second deal rooms. Such changes can be based on one or more data points related to the offers, as noted above. In this manner, incoming offers can be aggregated and benefit substantially all the buyers associated with the seller. In addition, a seller can exercise greater control over the planning and production of goods for sale.

It is to be appreciated that any programming methodology and/or computer architecture suitable for carrying out the subject invention may be employed and are intended to fall within the scope of the hereto appended claims.

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the subject invention is intended to embrace all such alterations, modifications and variations that fall within the spirit and scope of the appended claims. Furthermore, to the extent that the term “includes or having” is used in either the detailed description or the claims, such term is intended to be inclusive in a manner similar to the term “comprising” as “comprising” is interpreted when employed as a transitional word in a claim.

What is claimed is:

1. A non-transitory computer readable storage medium having embodied thereon instructions executable by a processor to:
provide an electronic forum for at least one seller to present at least one deal for a product or service to at least one buyer;
permit the at least one seller to offer the at least one deal to the at least one buyer, wherein the at least one deal presents a discounted price for the product or service that is available for a certain time period;
present an offer to the at least one buyer based on a buyer profile, wherein the buyer profile is comprised at least in part of information about the at least one buyer collected from registration, transactional data, geographical data or information provided, known, or inferred about the at least one buyer or a potential buyer;
enable the at least one buyer to agree to accept terms and conditions of the at least one deal including delivery of the product or service within a period of time, wherein the period of time indicates a time when the at least one deal is no longer available;
create an account associated with a provider of the electronic forum for the at least one buyer;
provide a verified form of payment associated with the account or have payment information entered by the at least one buyer when placing an order for the product or service; and
allow the at least one buyer to purchase the at least one deal from the at least one seller and have the at least one deal saved to the account of the at least one buyer.

2. The non-transitory computer readable storage medium of claim 1, further comprising instructions executable by a processor to determine a price for the at least one deal to present to the at least one buyer based at least in part on information know or inferred about the at least one buyer.

3. The non-transitory computer readable storage medium of claim 1, wherein the at least one deal is based at least in part on a price estimate or delivery time of the order.

4. The non-transitory computer readable storage medium of claim 1, wherein the at least one deal is a standard deal, a different deal, a deal with a different price, a deal with a potential price change, a deal with different terms or conditions, a deal with multiple prices, or not a deal.

5. The non-transitory computer readable storage medium of claim 1, wherein the information about the at least one buyer is collected or inferred to develop the buyer profile.

6. The non-transitory computer readable storage medium of claim 1, further comprising instructions executable by a processor to store data in a database to track price variances or delivery variances of the product or service.

7. The non-transitory computer readable storage medium of claim 1, further comprising instructions executable by a processor to record offers made to the at least one buyer to document which of the offers were successfully completed.

8. The non-transitory computer readable storage medium of claim 1, further comprising instructions executable by a processor to present a list of shipping options or corresponding prices for the product or service to the at least one buyer.

9. The non-transitory computer readable storage medium of claim 1, wherein the at least one seller specifies a certain minimum price or quantity for the offer.

10. The non-transitory computer readable storage medium of claim 1, further comprising instructions executable by a processor to present different offers to the at least one buyer, wherein the different offers include one or more of discounts, coupons, or a percent off if the at least one buyer agrees to place the order.

11. The non-transitory computer readable storage medium of claim 1, wherein a pricing scheme for the at least one deal is presented to the at least one buyer once the at least one buyer is identified.

12. The non-transitory computer readable storage medium of claim 1, further comprising instructions executable by a processor to assign a discounted price to the at least one buyer based on delivery time of the product or service.

13. A method, comprising:
providing an electronic forum for at least one seller to present at least one deal for a product or service to at least one buyer;
permitting the at least one seller to offer the at least one deal to the at least one buyer, wherein the at least one deal presents a discounted price for the product or service that is available for a certain time period;
presenting an offer to the at least one buyer based on a buyer profile, wherein the buyer profile is comprised at least in part of information about the at least one buyer collected from registration, transactional data, geographical data or information provided, known, or inferred about the at least one buyer or a potential buyer;
enabling the at least one buyer to agree to accept terms and conditions of the at least one deal including the delivery of the product or service within a period of time, wherein the period of time indicates a time when the at least one deal is no longer available;
creating an account associated with a provider of the electronic for the at least one buyer;
providing a verified form of payment associated with the account or have payment information entered by the at least one buyer when placing an order for the product or service; and
allowing the at least one buyer to purchase the at least one deal from the at least one seller and have the at least one deal saved to the account of the at least one buyer.

14. The method of claim 13, further comprising determining a need for the product or service, viewing inventory of the product or service provided by the at least one seller, ordering the product or service for delivery, receiving the discounted price for the product or service based in part on a delivery date associated with the order.

15. The method of claim 13, further comprising determining a price curve for the at least one deal to present to the at least one buyer based at least in part on information know or inferred about the at least one buyer and/or delivery time of the product or service.

16. The method of claim 13, further comprising presenting a list of delivery options and corresponding prices for the product or service to the at least one buyer.

17. The method of claim 13, further comprising storing data in a database to track price variances or delivery variances of the product or service.

18. A non-transitory computer readable storage medium having embodied thereon instructions executable by a processor to:
maintain an electronic forum for at least one seller to present at least one deal for a good or service to at least one buyer;
allow the at least one seller to present the at least one deal to the at least one buyer, wherein the at least one deal presents a discounted price for the good or service that is available for a certain time period;
generate an offer for the at least one buyer based on a buyer profile, wherein the buyer profile is comprised at least in part of information about the at least one buyer collected from registration, transactional data, geographical data or information provided, known, or inferred about the at least one buyer or a potential buyer;
enable the at least one buyer to agree to accept terms and conditions of the at least one deal including the delivery of the good or service within a period of time, wherein the period of time indicates a time when the at least one deal is no longer available;
create an account associated with a provider of the electronic forum for the at least one buyer;
present a verified form of payment associated with the account or have payment information entered by the at least one buyer when placing an order for the good or service; and
provide the at least one buyer an ability to purchase the at least one deal from the at least one seller and have the at least one deal saved to the account of the at least one buyer.

19. The non-transitory computer readable storage medium of claim 18, further comprising instructions executable by a processor to determine a discounted price for the at least one deal to present to the at least one buyer based at least in part on information known or inferred about the at least one buyer.

20. The non-transitory computer readable storage medium of claim 18, wherein the at least one deal is based on a price estimate or a delivery date associated with the order.
